(19) United States
(12) Patent Application Publication
(10) Pub. No.: US 2024/0069585 A1
(43) Pub. Date: Feb. 29, 2024

(54) PASSIVE PEDAL FORCE EMULATOR ASSEMBLY HAVING TENSION MEMBERS

(71) Applicant: KSR IP Holdings, LLC, Wilmington, DE (US)

(72) Inventors: DAVID BURK, Blenheim (CA); Michael D. Olajos, South Woodslee (CA); Jason Segeren, Blenheim (CA); Matthew Vyskocil, Ridgetown (CA)

(73) Assignee: KSR IP Holdings, LLC, Wilmington, DE (US)

(21) Appl. No.: 18/240,650

(22) Filed: Aug. 31, 2023

Related U.S. Application Data
(60) Provisional application No. 63/402,722, filed on Aug. 31, 2022.

(51) Int. Cl. G05G 5/03; G05G 1/44

(52) U.S. Cl. CPC G05G 5/03; G05G 1/44; G05G 5/05

(57) ABSTRACT

A pedal assembly is provided that includes a housing, a pedal arm, and at least one tension member. The housing includes a cavity and an interior surface. The pedal arm has a hub portion at one end positioned within the cavity and a pedal pad positioned on an another end. The hub portion is movably coupled to the housing. The hub portion has an engagement surface. The at least one tension member has a distal end and an opposite proximal end. The distal end is configured to engage with the engagement surface of the hub portion. When a first predetermined load is applied to the pedal pad, the hub portion moves which drives the at least one tension member against the interior surface of the housing such that at least a tension by the at least one tension member generates a first force feedback onto the pedal pad.

### CROSS-REFERENCE TO RELATED APPLICATIONS

This utility patent application claims priority benefit from U.S. Provisional Patent Application Ser. No. 63/402,722, filed Aug. 31, 2022, and entitled “Passive Pedal Force Emulator Having Leaf Springs”, the contents of which is incorporated herein in its entirety.

### TECHNICAL FIELD

The present specification generally relates to pedal assemblies for vehicles and, more specifically, to passive force emulator based on a pedal movement.

### BACKGROUND

Many braking system are passive driven. However, newer braking system are now utilizing an e-boost braking system where a boost of the braking system is provided by an electric motor to provide an active force to the braking system. As such, the need for mechanical braking by the operator is on the decline, being replace with a need for system components of the braking system to perform the braking on behalf of the operator is increasing. While the mechanism of braking is switching, there remains a need for the operator to receive resistive feedback as the brake pedal is deployed in order to garner a sense to the extent of braking force actually applied. In other words, despite the progress in moving to the motor assisting in halting the vehicle, there is a need for a passive force emulator to provide a haptic feel to the operator when a pedal is depressed.

### SUMMARY

In one embodiment, a pedal assembly is provided. The pedal assembly includes a housing, a pedal arm, and at least one tension member. The housing includes a cavity and an interior surface. The pedal arm has a hub portion at one end positioned within the cavity of the housing and a pedal pad positioned on another end of the pedal arm. The hub portion is movably coupled to the housing. The hub portion has an engagement surface. The at least one tension member has a distal end and an opposite proximal end. The distal end is configured to engage with the engagement surface of the hub portion. When a first predetermined load is applied to the pedal pad, the hub portion moves which drives the at least one tension member against the interior surface of the housing such that at least a tension by the at least one tension member generates a first force feedback onto the pedal pad.

In another embodiment, a pedal assembly is provided. The pedal assembly includes a housing, a pivoting member, a pedal arm, at least one tension member, and at least one spring member. The housing includes a cavity and an interior surface. The pivoting member is positioned in the cavity and pivotally coupled to the interior surface of the housing. The pivoting member has a lower flange extending from a distal end. The pedal arm has a hub portion at one end positioned within the cavity of the housing and a pedal pad positioned on another end of the pedal arm. The hub portion is movably coupled to the housing. The hub portion has an outer wall having an engagement surface. The at least one tension member has a distal portion and an opposite proximal end. The proximal end of the at least one tension member is configured to engage with the engagement surface of the hub portion and the distal portion is configured to engage with the lower flange. The at least one spring member extending from an inner surface of the pivoting member towards the pedal arm and configured to be compressed by the pedal arm. When a first predetermined load is applied to the pedal pad, the pedal arm at least partially compresses the at least one spring member towards the inner surface of the pivoting such that the at least one spring member generates a first force feedback onto the pedal pad.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a passive pedal force emulator assembly according to one or more embodiments shown and described herein;

FIG. 2 schematically depicts a partial isolated perspective view of a first embodiment of an emulator assembly of the passive pedal force emulator assembly of FIG. 1 according to one or more embodiments shown and described herein;

FIG. 3 schematically depicts a cross sectional view of the emulator assembly of FIG. 2 taken from line 2-2 with a first predetermined load applied according to one or more embodiments shown and described herein;

FIG. 4 schematically depicts a cross sectional view of the emulator assembly of FIG. 2 taken from line 2-2 with a second predetermined load applied according to one or more embodiments shown and described herein;

FIG. 5 schematically depicts a cross sectional view of the emulator assembly of FIG. 2 taken from line 2-2 with a third predetermined load applied according to one or more embodiments shown and described herein;

FIG. 6 schematically depicts a partial isolated perspective view of a second embodiment of an emulator assembly of the passive pedal force emulator assembly of FIG. 1 according to one or more embodiments shown and described herein;

FIG. 7 schematically depicts a cross sectional view of the emulator assembly of FIG. 6 taken from line 6-6 with a first predetermined load applied according to one or more embodiments shown and described herein;

FIG. 8 schematically depicts a cross sectional view of the emulator assembly of FIG. 6 taken from line 6-6 with a second predetermined load applied according to one or more embodiments shown and described herein;

FIG. 9 schematically depicts a cross sectional view of the emulator assembly of FIG. 6 taken from line 6-6 with a third predetermined load applied according to one or more embodiments shown and described herein;

FIG. 10 schematically depicts a partial isolated perspective view of a third embodiment of an emulator assembly of the passive pedal force emulator assembly of FIG. 1 according to one or more embodiments shown and described herein;

FIG. 11 schematically depicts a cross sectional view of the emulator assembly of FIG. 10 taken from line 10-10 with a first predetermined load applied according to one or more embodiments shown and described herein;

FIG. 12 schematically depicts a cross sectional view of the emulator assembly of FIG. 10 taken from line 10-10 with a second predetermined load applied according to one or more embodiments shown and described herein;

FIG. 13 schematically depicts a cross sectional view of the emulator assembly of FIG. 10 taken from line 10-10 with a third predetermined load applied according to one or more embodiments shown and described herein;

FIG. 14 schematically depicts a partial isolated perspective view of a fourth embodiment of an emulator assembly of the passive pedal force emulator assembly of FIG. 1 according to one or more embodiments shown and described herein;

FIG. 15 schematically depicts a cross sectional view of the emulator assembly of FIG. 14 taken from line 14-14 with a first predetermined load applied according to one or more embodiments shown and described herein;

FIG. 16 schematically depicts a cross sectional view of the emulator assembly of FIG. 14 taken from line 14-14 with a second predetermined load applied according to one or more embodiments shown and described herein;

FIG. 17 schematically depicts a cross sectional view of the emulator assembly of FIG. 14 taken from line 14-14 with a third predetermined load applied according to one or more embodiments shown and described herein;

FIG. 18 schematically depicts a partial isolated perspective view of the first embodiment of the emulator assembly of FIG. 2 including a pair of spring members according to one or more embodiments shown and described herein;

FIG. 19 schematically depicts a partial isolated perspective view of the second embodiment of the emulator assembly of FIG. 6 including a pair of spring members according to one or more embodiments shown and described herein;

FIG. 20 schematically depicts a partial isolated perspective view of the first embodiment of the emulator assembly of FIG. 10 including a pair of spring members according to one or more embodiments shown and described herein;

FIG. 21 schematically depicts a partial isolated perspective view of the first embodiment of the emulator assembly of FIG. 14 including a pair of spring members according to one or more embodiments shown and described herein;

FIG. 22 schematically depicts an illustrative example graph of a pedal travel versus an apply force according to one or more embodiments shown and described herein; and

FIG. 23 schematically depicts an illustrative example graph of a pedal travel versus a hysteresis force according to one or more embodiments shown and described herein.

### DETAILED DESCRIPTION

A brake pedal emulator (BPE) is a device that takes the place of a brake pedal and other hardware and is be used on an Electromechanical Braking System where there is no direct mechanical or hydraulic connection between the brake pedal and the calipers. The BPE inputs are force and travel distance from the driver's foot, reference voltage for all sensors, ground for all sensors, reaction loads at all fastening points. The BPE outputs are force feedback/resistance to driver's foot as a function of travel and speed, multiple pedal position sensor outputs as a function of travel, and error codes relating to the sensor outputs. Optional function is the conditioning of the output signals to provide the driver's intended braking input signal. The intention is that the BPE behaves to the driver as closely as possible as a conventional braking system in terms of pedal feel and deceleration performance.

The BPE may be located in a driver's footwell area. The BPE needs to meet the same mechanical loads as conventional pedal assemblies and must behave in a similar way as the conventional pedal. For example, the BPE needs to behave similar to conventional pedals when respect to applying loads, lateral loads, reverse loads vs. deflections and plastic deformation.

Conventional brake pedal assemblies include a pedal mounting bracket with a pivotally attached pedal arm/lever that has certain pedal force characteristics that need to be met during the apply stroke of the pedal. As such, the BPE needs to be configured to meet these same certain pedal force characteristics. Further, in some embodiments, the BPE may also include a downstop for the brake pedal stroke. Additionally, the BPE needs to be configured to withstand panic braking loads.

The BPE assemblies disclosed herein meet the following criteria: The BPE fails functional such that upon any failure, the driver is permitted to operate the braking system by applying the pedal and provide an appropriate sensor signal output. The BPE is configured to withstand foreseeable conditions and abuse a pedal will take. The BPE is scalable to automotive volume series production and be cost effective to manufacture and assemble.

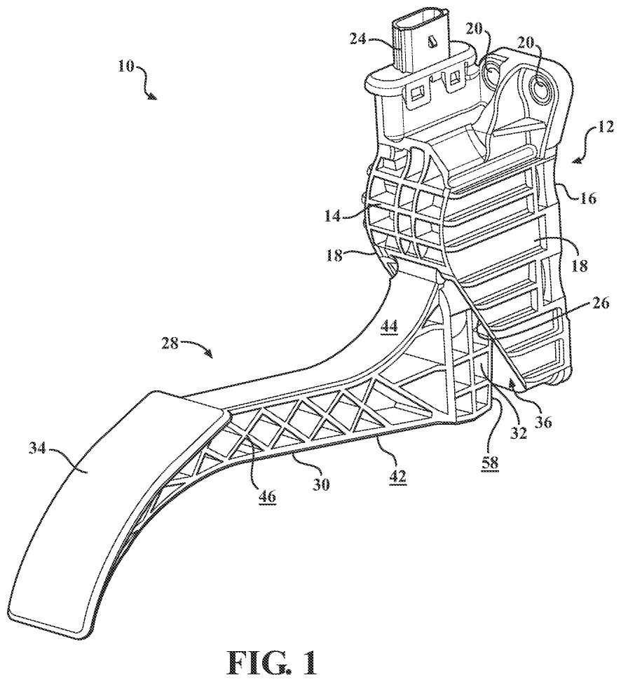

As used herein, the term “longitudinal direction” refers to the forward-rearward direction of the assembly (i.e., in the +/−X-direction depicted in FIG. 1). The term “lateral direction” refers to the cross-assembly direction (i.e., in the +/−Y-direction depicted in FIG. 1), and is transverse to the longitudinal direction. The term “vertical direction” or “below” or “above” refer to the upward-downward direction of the assembly (i.e., in the +/−Z-direction depicted in FIG. 1).

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, data signals wirelessly and/or via conductive medium or a non-conductive medium and the like.

Referring initially to FIG. 22, schematically depicted is an example illustrative graph depicting a desired force response curve for a pedal. As can be seen, as the pedal travels the greater the apply force that is required. The force is non-linear and increases significantly near the end of the travel of the pedal. This type of force response is typically found in a mechanical pedal design where there is a linkage either mechanically or hydraulically coupled with the brake calipers. As a pedal effort (PE) is applied to the pedal, the pedal arm pivots to allow the pedal to travel. The emulator applies an opposite emulator force (EF) to provide the driver with a resistive force that changes according to the speed in which the PE is applied.

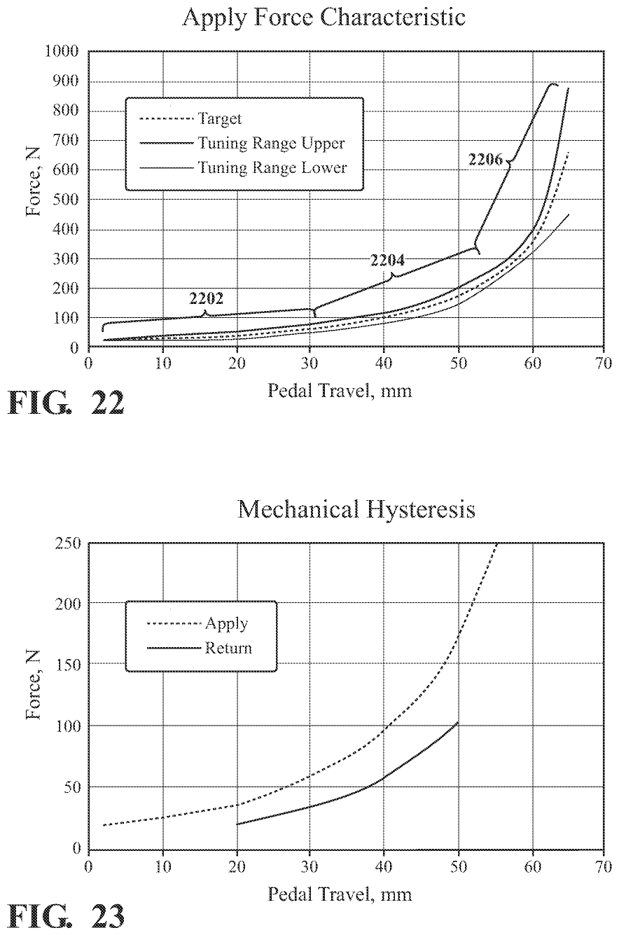

Now referring to FIG. 23, schematically depicted is an example illustrative graph depicting a desired mechanical hysteresis in terms of a force as a function of the pedal position. As illustrated in FIG. 23, the curve has a similar shape to the apply force denoted in FIG. 22. It is desirable to have such force responses in a drive by wire braking system without a mechanical linkage. Such a system will include a brake pedal emulator that is substitute for a mechanically linked brake pedal.

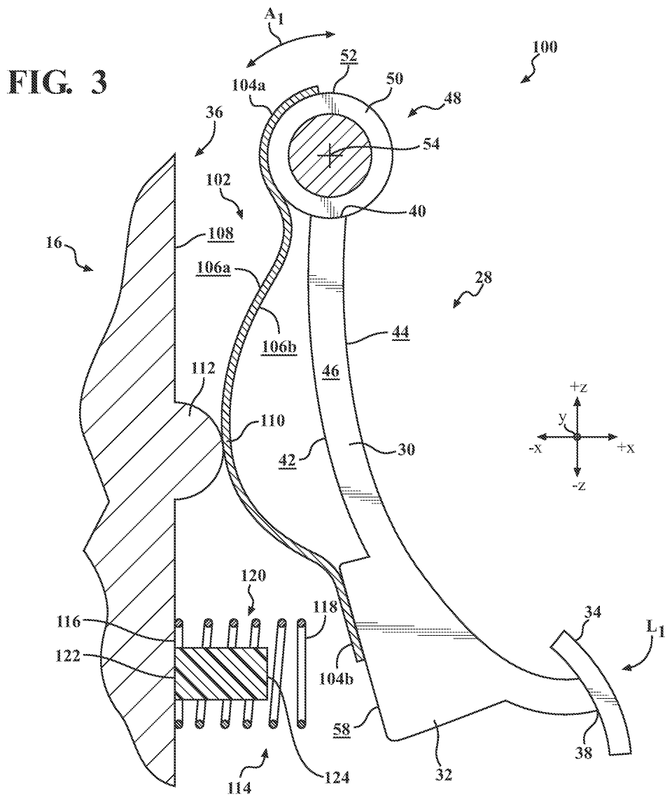

Referring now to FIG. 3, an example pedal emulator assembly 10 is schematically depicted. While a brake pedal is depicted in the illustrated embodiments, this is non-limiting and the pedal emulator assembly may be used in clutch and/or accelerator pedal assembly applications. The example pedal emulator assembly 10 includes a housing 12 for securing the example pedal emulator assembly 10 to a portion of the automotive vehicle. In the illustrated example, the housing 12 is attached to a portion of the firewall (not shown) of the vehicle.

The housing 12 may include a front wall 14, an opposite rear wall 16, and a pair of opposing sidewalls 18 which traverse the front wall 14 and the rear wall 16. The rear wall 16 of the housing 12 is formed of a generally planar surface for attaching the housing 12 to the firewall (not shown) of the vehicle. The rear wall 16 includes at least one aperture 20 for securing the housing 12 to the vehicle using any known fastener or attaching means to secure one object to another illustratively including bolting, screwing, welding, or adhesive. A connector 24 is affixed or extends from the housing 12 for the attachment of a vehicle-side wiring harness (not shown). The wiring harness transmits the signal from a position sensor to the vehicle control such as a brake assembly or throttle control to control the vehicle operation.

In some embodiments, the housing 12 may generally be a boxlike structure having a cavity 36 or interior portion defined by the rear wall 16, front wall 14, and the sidewalls 18. The front wall 14 includes an opening 26 through which a portion of a pedal arm 28 extends. In other embodiments, the housing 12 may take on any shape, whether regular or irregular, and may be formed via injection molding techniques, additive manufacturing techniques (e.g., three-dimensional printing), and the like.

In some embodiments, the housing 12 may be formed with various materials such as acrylonitrile butadiene styrene (ABS), polyethylene (PE), polypropylene (PP), polycarbonate (PC), polyamide thermoplastic (PA) —known as nylon—and variations of nylon including PA6 and PA66, Polyphthalamide (PPA), polycarbonate/acrylonitrile butadiene styrene, polyurethane, polymethyl methacrylate, high density polyethylene, low density polyethylene, polystyrene, PEEK, POM (Acetal/Delrin), polyethylene terephthalate, thermoplastic elastomer, polyetherimide, thermoplastic vulcanizate, polysulfone, and/or the like, and combinations thereof. Additionally, additives may be added such as UV absorbers, flame retardants, colorants, glass fibers, plasticizers, carbon fiber, aramid fiber, glass bead, PTFE, PFPE, TALC, MoS2 (Molybdenum Disulfide), graphite, and/or the like.

Now referring to FIGS. 1-5, in some embodiments, the pedal arm 28 may generally have an L-shaped configuration defined by an elongated member 30 that includes a distal end 38 and an opposite proximal end 40, an inner surface 42, an opposite outer surface 44, and pair of side surfaces 46 positioned to transverse the inner surface 42 and the outer surface 44. In other embodiments, the pedal arm 28 may be any shape including, without limitation, an arcuate or curvilinear shape, a linear shape, and the like. A pedal pad 34 is secured to the distal end 38 (e.g., lower end) of the elongated member 30. In this example, the pedal pad 34 has a generally rectangular shape and is formed of an isometric material such as a rubber as the pedal pad 34 contacts the foot of a driver so as to control vehicle operations. A hub portion 48 extends from the proximal end 40 of the elongated member 30. In some embodiments, the hub portion 48 is integrally formed with the proximal end 40 of the elongated member 30 to be a monolithic single structure with the elongated member 30. In other embodiments, the hub portion 48 may be coupled or otherwise attached to the proximal end 40 of the elongated member 30. For example, the hub portion 48 may be coupled or otherwise attached to the proximal end 40 of the elongated member 30 via a fastener such as a bolt and nut, screws, rivets, weld, epoxy, adhesive, and/or the like.

The hub portion 48 may have a generally circumferential outer wall 50 with an engagement surface 52. In some embodiments, hub portion 48 may further have a center portion 54 which may be rotatably mounted to the housing 12 in any known manner such as an engagement of pins, rods, and the like, extending from or into the center portion 54 of the hub portion 48. As such, the hub portion 48 rotates about the center portion 54, which defines a pivot axis for the pedal arm 28. The rotation of the hub portion 48 about the center portion 54 may be sensed by a position sensor 56, such as a non-contacting position sensor using inductive sensing techniques and/or Hall Effect sensing techniques. In an inductive sensing example, the position sensor 56 may utilize coils mounted on a circuit board in order to create eddy currents, which are measured and then delivered to the vehicle control such as the brake assembly or the throttle control for controlling operation of the vehicle. The signals generated by the position sensor 56 are transferred to the vehicle controls via the wiring harness attached to the connector 24.

In the alternative, the position sensor 56 is a Hall Effect type sensor that detects changes in a magnetic field strength influenced by a coupler may be magnetic and mounted to the hub portion 48 such that the rotation or movement of the hub portion 38 may be accurately sensed. Further, the position sensor 56 may be connected to a circuit board (not shown) which engages with the connector 24 to transmit the position signals to the vehicle controls via the wiring harness. It is appreciated, of course, that various other types of positioning sensors may be utilized without deviation from the scope of the invention.

A contact member 32 may extend from the inner surface 42 in a direction opposite of the outer surface 44 at a position between the proximal end 40 and the distal end 38. In some embodiments, the contact member 32 is integrally formed with the inner surface 42 of the elongated member 30 to be a monolithic single structure with the elongated member 30. In other embodiments, the contact member 32 may be coupled or otherwise attached to the inner surface 42 of the elongated member 30. For example, the contact member 32 may be coupled or otherwise attached to the inner surface 42 of the elongated member 30 via a fastener such as a bolt and nut, screws, rivets, weld, epoxy, adhesive, and/or the like. The contact member 32 is configured to move upon any load added or removed from the pedal pad 34 to make contact with various emulator assembly components, as discussed in greater detail herein. As such, the contact member 32 may include a contact surface 58 that extends in the longitudinal direction (i.e., in the +/−X direction) a greater distance towards the interior wall surface 108 of the rear wall 16 than compared to the inner surface 42 of the elongated member 30. In some embodiments, the contact surface 58 may be an extension of or form a portion of the inner surface 42 of the elongated member. The contact surface 58 may generally be a planar surface that extends from the elongated member 30.

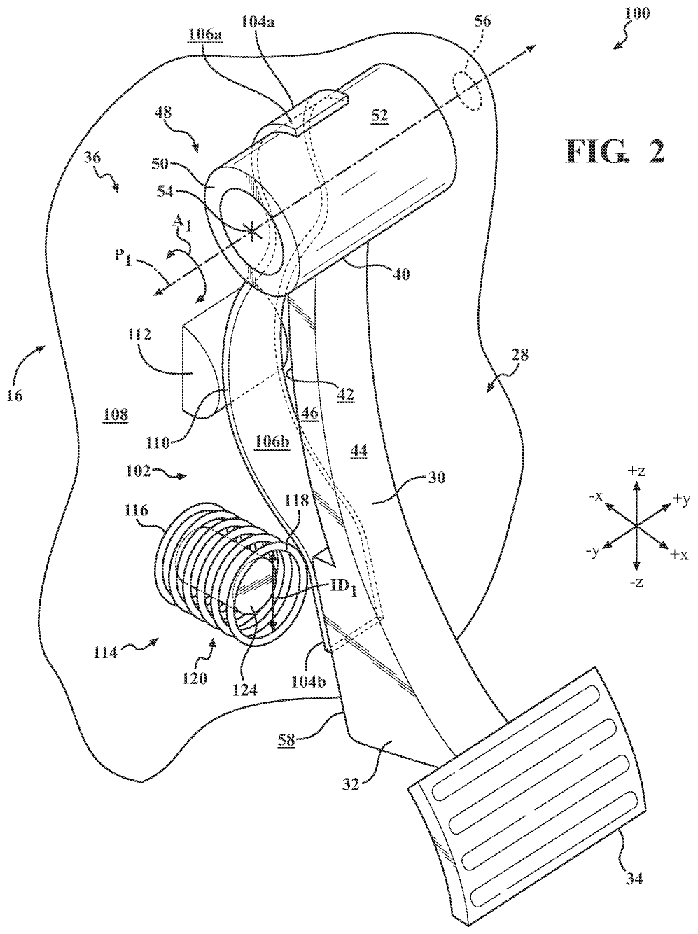

Now referring to FIGS. 2-5, a first example embodiment of an emulator assembly 100 is schematically depicted. In this embodiment, a tension member 102 extends from the hub portion 48 to the contact member 32. The tension member 102 may be a spring member such as a leaf spring that has a predetermined tension. As such, the leaf spring may be known as a laminated, carriage spring, semi-elliptical spring, elliptical spring, or cart spring, and is known to be generally rectangular and thin, which allows the leaf spring to flex in response to various influences applied to the spring, such as the housing and/or pedal arm 28, as discussed in greater detail herein.

The tension member 102 includes a hub engagement end 104a at or near a proximal end 40 and an opposite contact member end 104b positioned at or near a distal end. Further, the tension member 102 includes an interior surface 106a and an opposite exterior surface 106b spaced apart from the interior surface 106a to define a thickness. The exterior surface 106b of the tension member 102 may face the inner surface 42 of the elongated member 30 and the interior surface 106a of the tension member 102 may face the interior wall surface 108 of the rear wall 16 of the housing 12. The contact member end 104b may be configured to abut, engage, or otherwise be in communication with the contact member 32.

The tension member 102 may be curvilinear or arcuate in shape. The shape of the tension member 102 may assist in defining the predetermined tension of the tension member 102. As such, in this embodiment, the tension member 102 is shaped such that a mid-portion 110 or apex of a curve of the tension member 102 is the furthest or greatest distance away from the interior surface 106a in the longitudinal direction (i.e., in the +/−X direction) towards the interior wall surface 108 of the rear wall 16 of the housing 12. The mid-portion 110 or apex of the tension member 102 may be configured to abut, engage with, or otherwise be in communication with a protrusion 112 extending from the interior wall surface 108 of the rear wall 16 of the housing 12. The protrusion 112 may be rounded, semi-circular, condyle, oval, nonagon, decagon, square, cone, rectangular, and/or the like.

The hub engagement end 104a may be dimensioned and geometrically shaped to match the curvature of the circumferential outer wall 50. As such, portions of the exterior surface 106b at the hub engagement end 104a may abut, engage with, or otherwise be in communication with the engagement surface 52 of the circumferential outer wall 50 of the hub portion 48. As illustrated, in some embodiments, only portions of the exterior surface 106b at the hub engagement end 104a may abut, engage with, or otherwise be in communication with portions of the engagement surface 52 of the circumferential outer wall 50 of the hub portion 48.

In some embodiments, the hub engagement end 104a of the tension member 102 is held in a position or arrangement to abut, engage with, or otherwise be in communication with the engagement surface 52 of the circumferential outer wall 50 of the hub portion 48 and the opposite contact member end 104b is held in a position or arrangement to engage with, or otherwise be in communication with the contact surface 58 of the contact member 32 by a resting tension of the tension member 102 (as best shown in FIG. 3) generated or created by the shape of the tension member 102, and/or the contact, engagement, otherwise in communication with the protrusion 112 extending from the interior wall surface 108 of the rear wall 16 of the housing 12 and/or the engagement or communication with the contact surface 58 of the contact member 32. As such, in this embodiment, the tension member 102 may be independent from or otherwise not permanently coupled or attached to the pedal arm 28 or components thereof, and instead the positioning, shape, and contact points, portions, and/or positioning of the tension member 102 generates the tension needed or required to maintain the tension member 102 under a constant resting tension to maintain the positioning of the tension member 102 in the emulator assembly 100. As such, the tension member 102 is held in position by a tension fit.

In other embodiments, the hub engagement end 104a of the tension member 102 is coupled or otherwise attached to the engagement surface 52 of the circumferential outer wall 50 of the hub portion 48. The hub engagement end 104a of the tension member 102 may be coupled or otherwise attached via a fastener. Example fasteners include, without limitation, bolt and nut, screw, rivets, weld, epoxy, adhesive, and/or the like. As such, in this embodiment, instead of a tension fit, the hub engagement end 104a of the tension member 102 is held in a position or arrangement to abut, engage with, or otherwise be in communication with the engagement surface 52 of the circumferential outer wall 50 of the hub portion 48 via the fastener.

In other embodiments, the contact member end 104b of the tension member 102 is held in a position or arrangement to engage with, or otherwise be in communication with the contact surface 58 of the contact member 32 via a fastener. Example fasteners include, without limitation, bolt and nut, screw, rivets, weld, epoxy, adhesive, and/or the like. It should be understood that the contact member end 104b of the tension member 102 may be held in a position or arrangement to engage with, or otherwise be in communication with the contact surface 58 of the contact member 32 via the fastener while the hub engagement end 104a of the tension member 102 may be coupled to the or otherwise attached to the engagement surface 52 of the circumferential outer wall 50 of the hub portion 48 via the tension fit and vice versa (e.g., the hub engagement end 104a of the tension member 102 may be coupled to the or otherwise attached to the engagement surface 52 of the circumferential outer wall 50 of the hub portion 48 via the fastener and the contact member end 104b of the tension member 102 may be held in a position or arrangement to engage with, or otherwise be in communication with the contact surface 58 of the contact member 32 via the tension fit).

As such, the tension fit described herein requires nothing more than the tension or force generated or created by the tension member 102 that may be based on the shape and/or material of the tension member 102, the arrangement of the tension member 102 against the pedal arm 28 and/or the protrusion 112 of the housing 12, and the like.

Still referring to FIGS. 2-5 and now back to FIGS. 22-23, in operation, as a first predetermined load L1 is applied to the pedal pad 34, as best illustrated in FIG. 3, the engagement surface 52 of the circumferential outer wall 50 of the hub portion 48 may rotate, pivot, or otherwise move, about arrow A1, thereby concurrently or simultaneously moving, rotating, or pivoting the hub engagement end 104a of the tension member 102. Such movement causes the tension member 102 to generate or create an increasing tension due to the mid-portion 110 or apex of the tension member 102 abutting, engaging with, or otherwise be in communication with the protrusion 112 extending from the interior wall surface 108 of the rear wall 16 of the housing 12 and/or the opposite contact member end 104b, abutting, engaging with, or otherwise in communication with the contact surface 58 of the contact member 32.

As such, the tension generated or created by the tension member 102 is dependent on the amount of first predetermined load L1 applied to the pedal pad 34. That is, the hub portion 48 moves, which drives the tension member 102 towards the interior wall surface 108 of the housing 12 such that a tension generated or created the tension member 102 generates a first force feedback onto the pedal pad, illustrated by bracket 2202 in FIG. 22, dependent on the first predetermined load L1 applied to the pedal pad 34. Further, it should be understood that the tension member 102 also applies a return force to the pedal arm 28 when the first predetermined load L1 is reduced or eliminated from the application onto the pedal pad 34 such that the pedal arm 28 and pedal pad 34 may return to a home position when no load is applied to the pedal pad 34.

It should be realized that various pedals and pivot locations may be utilized. Further, it should be realized that the tension member 102 may be a series of leaf springs, or in combination with other springs, fixed to a structure. The structure may include various components such as a floor or back wall of a vehicle, ties or U-bolts, bonding fasteners, or other structure of a pedal assembly. Further, the tension member 102 or series of leaf springs may be cantilevered relative to the pedal arm 28 such that as the pedal arm 28 pivots or moves, the pedal arm 28 and components thereof pivot or move the tension member 102 or series of leaf springs to compress or otherwise manipulate the tension member 102 or series of tension members to successively apply a varying force to the pedal arm 28.

Now referring back to FIGS. 2-5, the first example emulator assembly 100 may further include at least one spring member 114 that extends in the cavity 36 and from the interior wall surface 108 of the rear wall 16 in the longitudinal direction (i.e., in the +/−X direction). The at least one spring member 114 may include a coupled end 116 and an opposite contact end 118 along with an inner diameter ID1 extending between the coupled end 116 and the contact end 118. The inner diameter ID1 is open or hollow such that a bore formed by the springs extends therethrough. The coupled end 116 may be fixedly coupled or otherwise attached to the interior wall surface 108 of the housing 12. As such, a fastener may be used to fixedly couple the contact end 118, for example, without limitation, the fastener may include bolt and nut, screw, rivet, hook and loop, weld, adhesive, epoxy, and/or the like. The contact end 118 is positioned to extend away from the interior wall surface 108 towards the contact member 32 of the pedal arm 28. Further, in the illustrated embodiment, the at least one spring member 114 is positioned below the protrusion 112 in the vertical direction (i.e., in the +/−Z direction). This is non-limiting and the at least one spring member 114 may be positioned anywhere within the cavity 36.

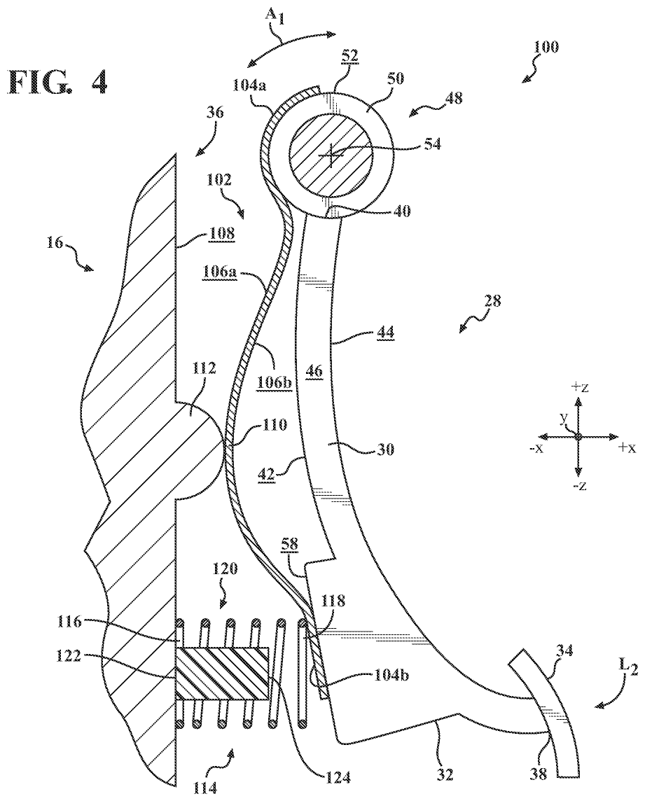

As such, the at least one spring member 114 extends within the cavity 36 of the housing 12 between the interior wall surface 108, the contact member end 104b of the tension member 102, and the contact surface 58 of the contact member 32. As such, the contact end 118 of the at least one spring member 114 may be configured to abut, engage with, or otherwise be in communication with both the contact member end 104b of the tension member 102, and the contact surface 58 of the contact member 32 when a second predetermined load L2 is applied to the pedal pad 34, which is greater than the first predetermined load L1, as best illustrated in FIG. 4.

As such, when the second predetermined load L2 is applied to the pedal pad 34, the contact member end 104b of the tension member 102 and/or the contact surface 58 of the contact member 32 may be abut, engage with, or otherwise be in communication with the contact end 118 of the at least one spring member 114 to at least partially compress the at least one spring member 114 dependent on the amount of load applied to the pedal pad 34.

As such, the tension generated or created by the at least one spring member 114 is dependent on the amount of the predetermined load L2 applied to the pedal pad 34 and the compression of the at least one spring member 114. The force generated by the compression of the at least one spring member 114 caused from contact between the interior wall surface 108 of the housing 12 and/or the contact surface 58 of the contact member 32 with the at least one spring member 114 generates a second force feedback onto the pedal pad 34, illustrated by bracket 2204 in FIG. 22, dependent on the second predetermined load L2 applied to the pedal pad 34. As illustrated, the second force feedback, illustrated by bracket 2204 in FIG. 22, applied onto the pedal pad 34, is a greater force or pedal effort than the first force feedback illustrated by bracket 2202 in FIG. 22. Further, the second predetermined load L2 is a greater energy or load than the energy inherent in the at least one spring member 114.

Once the force on the pedal pad 34 is reduced or eliminated, the energy of the at least one spring member 114 (e.g., potential and kinetic) may assist in applying a return force the pedal arm 28 when the second predetermined load L2 is reduced or eliminated from the application onto the pedal pad 34 such that the pedal arm 28 and pedal pad 34 may return to a position associated with the first predetermined load L1.

In some embodiments, the at least one spring member 114 may be formed with a steel material. In other embodiments, the at least one spring member 114 may be formed with stainless steel, wire, carbon steel, alloy steel, elgiloy, Monel®, copper, nickel, and/or the like. Further, in some embodiments, the at least one spring member 114 may be a coil spring. In other embodiments, the at least one spring member 114 may be a torsion spring, a tension spring, a conical spring, and/or the like.

Still referring to FIGS. 2-5, the first example emulator assembly 100 may further include at least one compressible member 120 that extends in the cavity 36 and from the interior wall surface 108 of the rear wall 16 in the longitudinal direction (i.e., in the +/−X direction). The at least one compressible member 120 may include an attachment end 122 and an opposite interaction end 124. The attachment end 122 may be fixedly coupled or otherwise attached to the interior wall surface 108 of the housing 12.

As such, a fastener may be used to fixedly couple the attachment end 122, for example, without limitation, bolt and nut, screw, rivet, hook and loop, weld, adhesive, epoxy, and/or the like. The attachment end 122 is positioned to extend away from the interior wall surface 108 towards the contact member 32 of the pedal arm 28. Further, in the illustrated embodiment, the at least one compressible member 120 is positioned below the protrusion 112 in the vertical direction (i.e., in the +/−Z direction). This is non-limiting and the at least one compressible member 120 may be positioned anywhere within the cavity 36.

As such, in the illustrated embodiment, the at least one compressible member 120 extends within the cavity 36 of the housing 12 between the interior wall surface 108, the contact member end 104b of the tension member 102, and the contact surface 58 of the contact member 32. In some embodiments, the at least one compressible member 120 may be configured to extend within the inner diameter ID1 of the at least one spring member 114. In other embodiments, the at least one compressible member 120 may extend next to, adjacent to, or in same cavity as the at least one spring member 114.

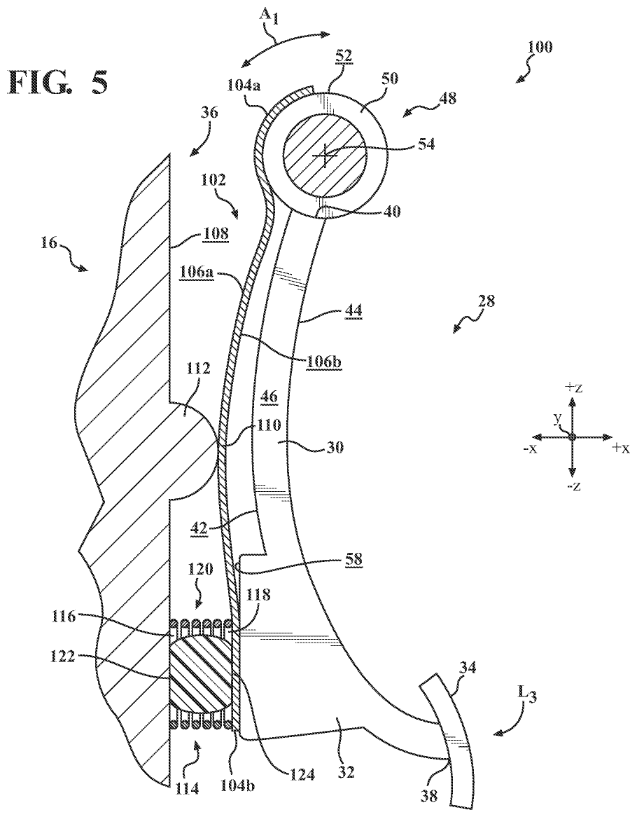

As such, the interaction end 124 of the at least one compressible member 120 may be configured to abut, engage with, or otherwise be in communication with both the contact member end 104b of the tension member 102, and the contact surface 58 of the contact member 32 when a third predetermined load L3 is applied to the pedal pad 34, which is greater than the second predetermined load L2, as best illustrated in FIG. 5.

As such, when the third predetermined load L3 is applied to the pedal pad 34, the contact member end 104b of the tension member 102 and/or the contact surface 58 of the contact member 32 may be abut, engage with, or otherwise be in communication with the interaction end 124 of the at least one compressible member 120 to compress and/or deform the at least one compressible member 120 dependent on the amount of load applied to the pedal pad 34.

As such, the tension generated or created by the at least one compressible member 120 is dependent on the amount of load L3 applied to the pedal pad 34 and the compression characteristics of the at least one compressible member 120. The force generated by the compression or deformation of at least one compressible member 120 caused from contact between the interior wall surface 108 of the housing 12 and the contact surface 58 of the contact member 32 generates a third force feedback onto the pedal pad 34, illustrated by bracket 2206 in FIG. 22, dependent on the third predetermined load L3 applied to the pedal pad 34. As illustrated, the third force feedback, illustrated by bracket 2206 in FIG. 22, applied onto the pedal pad 34, is a greater force or pedal effort than the second force feedback illustrated by bracket 2204 in FIG. 22. Further, the third predetermined load L3 is a greater energy or load than the energy inherent in the at least one compressible member 120.

In some embodiments, the at least one compressible member 120 may be resilient and moves between the uncompressed state and the compressed state as a function of the amount of force applied to the pedal pad 34. It should be understood that there is a plurality of semi-compressed states between the uncompressed state and the compressed state and each of these semi-compressed states produce a different stiffness characteristic based on the density and compression of the at least one compressible member 120. As such, the compression of the at least one compressible member 120 produces a sharp increase in slope compared to the increase produced by the tension member 102 and/or the at least one spring member 114, as illustrated in FIG. 22.

In some embodiments, the at least one compressible member 120 may be a microcellular foam. In some embodiments, the microcellular foam may be a microcellular silicone foam. In other embodiments, the microcellular foam may be a polyurethane foam. Further, the microcellular foam may have a density range of 100 kilogram per cubic meter (kg/m³) to 600 kg/m³. In some embodiments illustrated herein, the density range of the microcellular foam of the at least one compressible member 120 may be 200 kg/m³ to 500 kg/m³. In other embodiments, the at least one compressible member 120 may be an elastomer material such as a cured silicone rubber that may be applied as a liquid via a one-shot injection molding or other known methods to form any shape desired. In other embodiments, the at least one compressible member 120 may be a silicone rubber, natural rubber, or other elastomeric material that is formed using compression and other techniques and that is suitable for repetitive compression over millions of cycles and has temperature performance desired in pedal assembly applications. In embodiments, the elastomer material of the at least one compressible member 120 may have a stiffness characteristic of at least 100 newton-millimeters (N/mm) spring rate in an uncompressed state, or starting state. In some embodiments, the at least one compressible member 120 may have a stiffness characteristic of at least 150 newton-millimeters (N/mm) spring rate in an uncompressed state, or starting state.

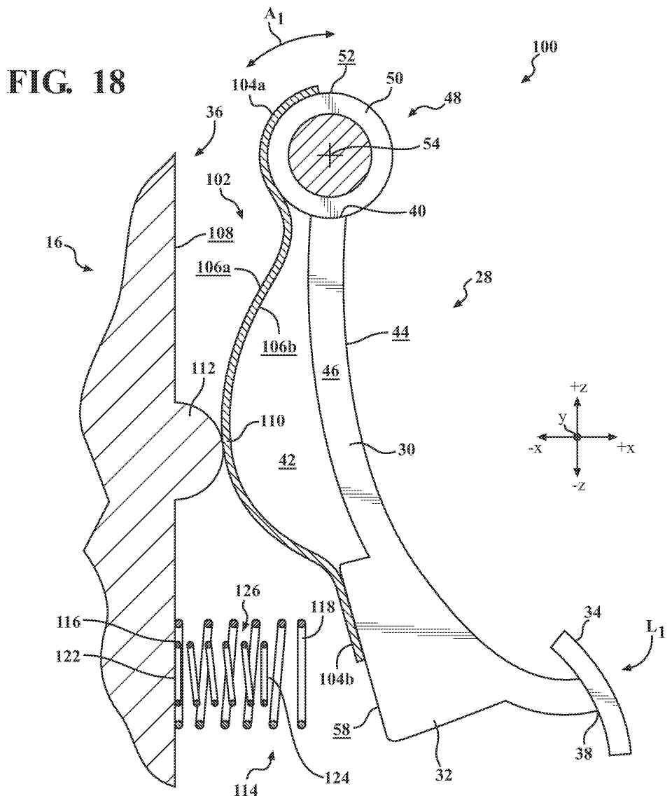

Now referring to FIG. 18, in other embodiments, the at least one compressible member 120 may be a second spring 126. The second spring 126 may have a greater compression rate (e.g., higher stiffness) compared to the at least one spring member 114 such that the second spring 126 produces the sharp increase in slope compared to the increase produced by the tension member 102 and/or the at least one spring member 114, as illustrated in FIG. 22. As such, the second spring 126 may replace the foam or elastomer material to generate the third force feedback applied to the pedal pad 34.

In some embodiments, the second spring 126 may be formed with a steel material. In other embodiments, the second spring 126 may be formed with stainless steel, wire, carbon steel, alloy steel, elgiloy, Monel®, copper, nickel, and/or the like. Further, in some embodiments, the second spring 126 may be a coil spring. In other embodiments, the second spring 126 may be a torsion spring, a tension spring, a conical spring, and/or the like.

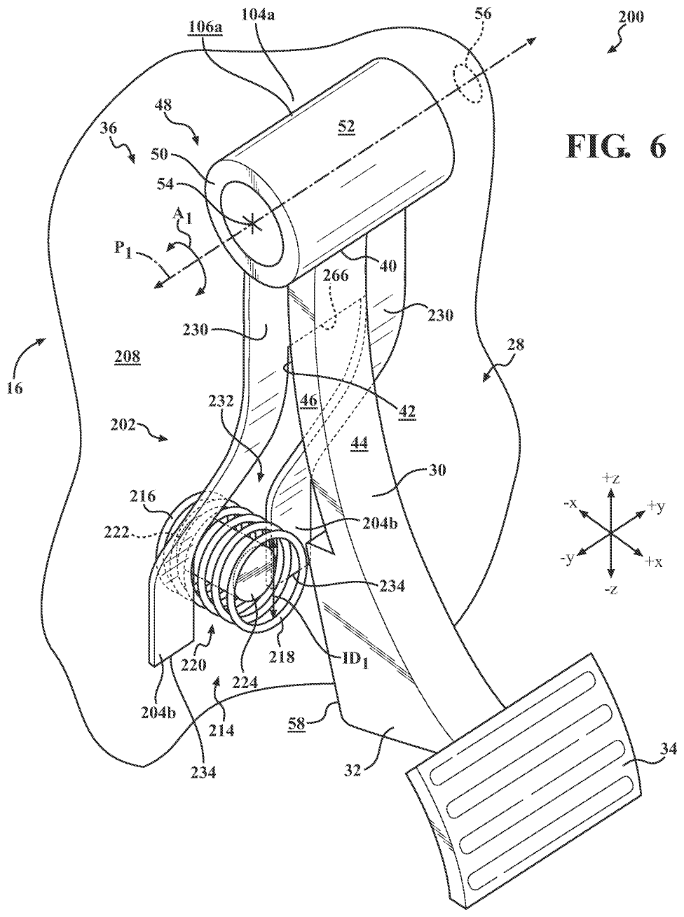

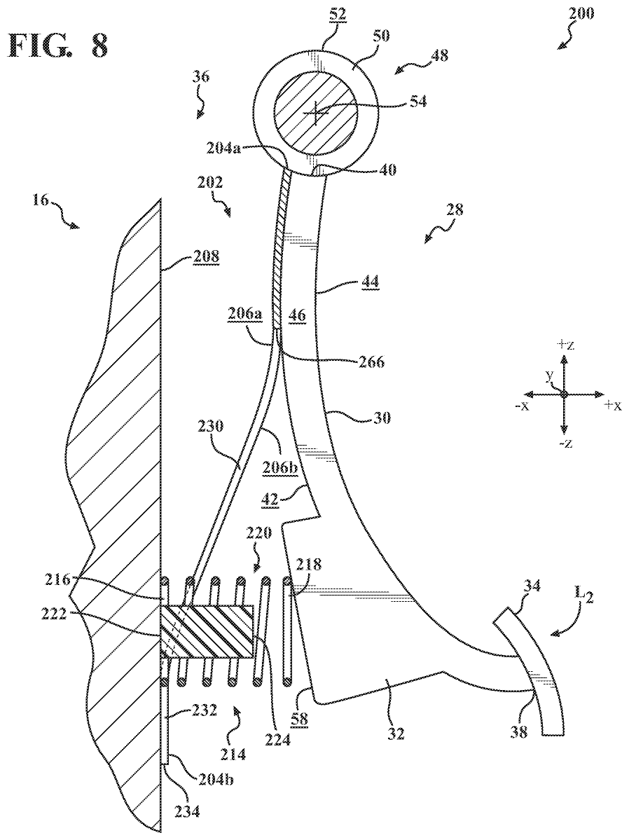

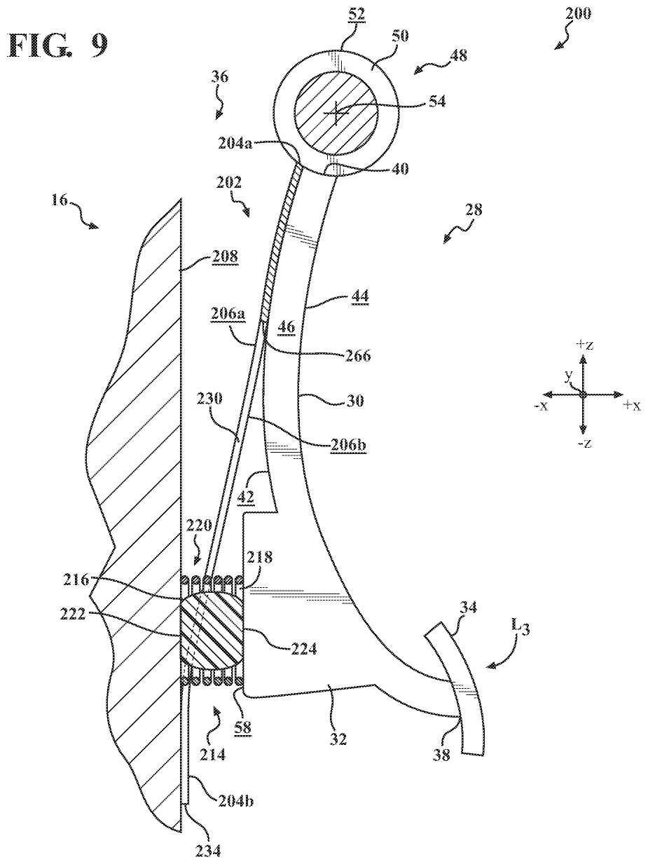

Now referring to FIGS. 6-9, a second aspect of an emulator assembly 200 is schematically depicted. It is understood that the emulator assembly 200 is similar to the emulator assembly 100 with the exceptions of the features described herein. As such, like features of the pedal assembly will use the same reference numbers and like features of the emulator assembly will use the same reference numerals with a prefix “2” for the reference numbers. As such, for brevity reasons, these features may not be described again.

In this embodiment, a tension member 202 extends from the hub portion 48 and/or from or adjacent to the proximal end 40 of the elongated member 30 to a position below the at least one spring member 214 and/or the at least one compressible member 220 in the vertical direction (i.e., in the +/−Z direction) to abut, engage, or otherwise be in communication with the interior wall surface 208 of the rear wall 16. In this embodiment, the contact member end 104b may be configured to abut, engage, or otherwise be in communication with the interior wall surface 208 of the rear wall 16.

The tension member 202 may be curvilinear or arcuate in shape. The shape of the tension member 202 may assist in defining the predetermined tension of the tension member 202. As such, in this embodiment, the tension member 202 is shaped such that the contact member end 204b may abut, engage, or otherwise be in communication with the interior wall surface 208 of the rear wall 16 and the hub engagement end 204a may abut, engage with, or otherwise be in communication with the engagement surface 52 of the circumferential outer wall 50 of the hub portion 48 and/or abut, engage with, or otherwise be in communication with the inner surface 42 of the elongated member 30.

The hub engagement end 204a may be dimensioned and geometrically shaped to match the curvature of the circumferential outer wall 50 and/or dimensioned and geometrically shaped to match the curvature of the inner surface 42 of the elongated member 30. In some embodiments, the hub engagement end 204a of the tension member 202 is held in a position or arrangement to abut, engage with, or otherwise be in communication with the engagement surface 52 of the circumferential outer wall 50 of the hub portion 48 and/or abut, engage with, or otherwise be in communication with the inner surface 42 of the elongated member 30.

In this embodiment, the contact member end 204b includes a pair of legs 230, tongues, or members, extending from a base portion 266, and that are each spaced apart by an opening 232 to form a general U-shape. As such, the contact member end 204b may be a pair of terminating ends 234 that are in contact with the interior wall surface 208 of the rear wall 16. In some embodiments, the pair of terminating ends 234 may terminate against the interior wall surface 208 of the rear wall at a position in the cavity 36 that is below the at least one spring member 214 and/or the at least one compressible member 220 in the vertical direction (i.e., in the +/−Z direction).

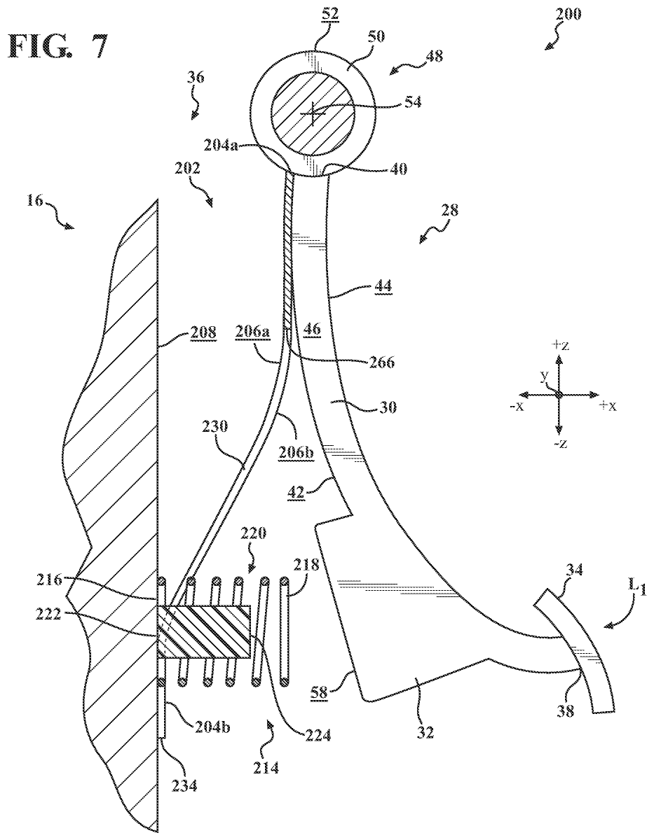

In some embodiments, the contact member end 204b (e.g., the pair of terminating ends 234) is held in a position or arrangement to engage with, or otherwise be in communication with the interior wall surface 208 of the rear wall 16 by the resting tension of the tension member 202 (as best shown in FIG. 7) generated or created by the shape of the tension member 202, and/or the contact, engagement, otherwise in communication with the pedal arm 28 and the interior wall surface 208 of the rear wall 16 of the housing 12.

As such, in this embodiment, the tension member 202 may be independent from or otherwise not permanently coupled or attached to the pedal arm 28 or components thereof, and instead the positioning, shape, and contact points, portions, and/or positioning of the tension member 202 generates the tension needed or required to maintain the tension member 202 under a constant resting tension to maintain the positioning of the tension member 202 in the emulator assembly 200. As such, the tension member 202 is held in position by a tension fit.

In other embodiments, the hub engagement end 204a of the tension member 202 is coupled or otherwise attached to the engagement surface 52 of the circumferential outer wall 50 of the hub portion 48 and/or to the inner surface 42 of the elongated member 30 of the pedal arm 28. The hub engagement end 204a of the tension member 202 may be coupled or otherwise attached via a fastener. Example fasteners include, without limitation, bolt and nut, screw, rivets, weld, epoxy, adhesive, and/or the like. As such, in this embodiment, instead of a tension fit, the hub engagement end 204a of the tension member 202 is held in a position or arrangement to abut, engage with, or otherwise be in communication with either the engagement surface 52 of the circumferential outer wall 50 of the hub portion 48 and/or with the inner surface 42 of the elongated member 30 via the fastener.

In other embodiments, the contact member end 204b (e.g., the terminating ends 234) of the tension member 102 is held in a position or arrangement to engage with, or otherwise be in communication with the interior wall surface 208 of the rear wall 16 via a fastener. Example fasteners include, without limitation, bolt and nut, screw, rivets, weld, epoxy, adhesive, and/or the like. It should be understood that the contact member end 204b of the tension member 202 may be held in a position or arrangement to engage with, or otherwise be in communication with the interior wall surface 208 of the rear wall 16 via the fastener while the hub engagement end 204a of the tension member 102 may be coupled to the or otherwise attached to either the engagement surface 52 of the circumferential outer wall 50 of the hub portion 48 and/or the inner surface 42 of the elongated member 30 via the tension fit and vice versa, as discussed above.

As such, the tension fit described herein requires nothing more than the tension or force generated or created by the tension member 202 that may be based on the shape and/or material of the tension member 202, the arrangement of the tension member 202 against the pedal arm 28 and/or the interior wall surface 208 of the housing 12, and the like.

Still referring to FIGS. 6-9 and now back to FIGS. 22-23, in operation, as a first predetermined load L1 is applied to the pedal pad 34, as best illustrated in FIG. 7, the engagement surface 52 of the circumferential outer wall 50 of the hub portion 48 and/or the elongated member 30 may rotate, pivot, or otherwise move, about arrow A1, thereby concurrently or simultaneously moving, rotating, or pivoting the hub engagement end 204a of the tension member 202. Such movement causes the tension member 202 to generate or create an increasing tension due to the terminating ends 234 of the contact member end 204b abutting, engaging with, or otherwise in communication with the interior wall surface 108 of the rear wall 16 of the housing 12.

As such, the tension generated or created by the tension member 202 is dependent on the amount of first predetermined load L1 applied to the pedal pad 34. That is, the hub portion 48 and/or the elongated member 30 moves, which drives the tension member 202 towards the interior wall surface 108 of the housing 12 such that a tension generated or created the tension member 202 generates the first force feedback onto the pedal pad 34, illustrated by bracket 2202 in FIG. 22, dependent on the first predetermined load L1 applied to the pedal pad 34.

Further, in the emulator assembly 200, the at least one spring member 214 and the at least one compressible member 220 extend between the pair of legs 230, tongues, or members, into the opening 232.

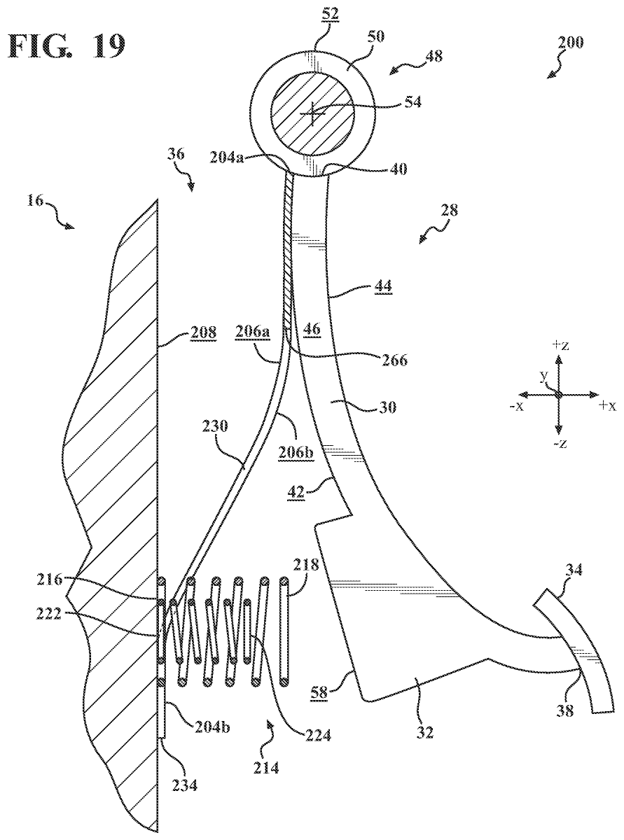

Now referring to FIG. 19, in other embodiments, the at least one compressible member 220 may be a second spring 226. The second spring 226 may have a greater compression rate (e.g., higher stiffness) compared to the at least one spring member 214 such that the second spring 226 produces the sharp increase in slope compared to the increase produced by the tension member 202 and/or the at least one spring member 214, as illustrated in FIG. 22. As such, the second spring 226 may replace the foam or elastomer material to generate the third force feedback applied to the pedal pad 34.

In some embodiments, the second spring 226 may be formed with a steel material. In other embodiments, the second spring 226 may be formed with stainless steel, wire, carbon steel, alloy steel, elgiloy, Monel®, copper, nickel, and/or the like. Further, in some embodiments, the second spring 226 may be a coil spring. In other embodiments, the second spring 226 may be a torsion spring, a tension spring, a conical spring, and/or the like.

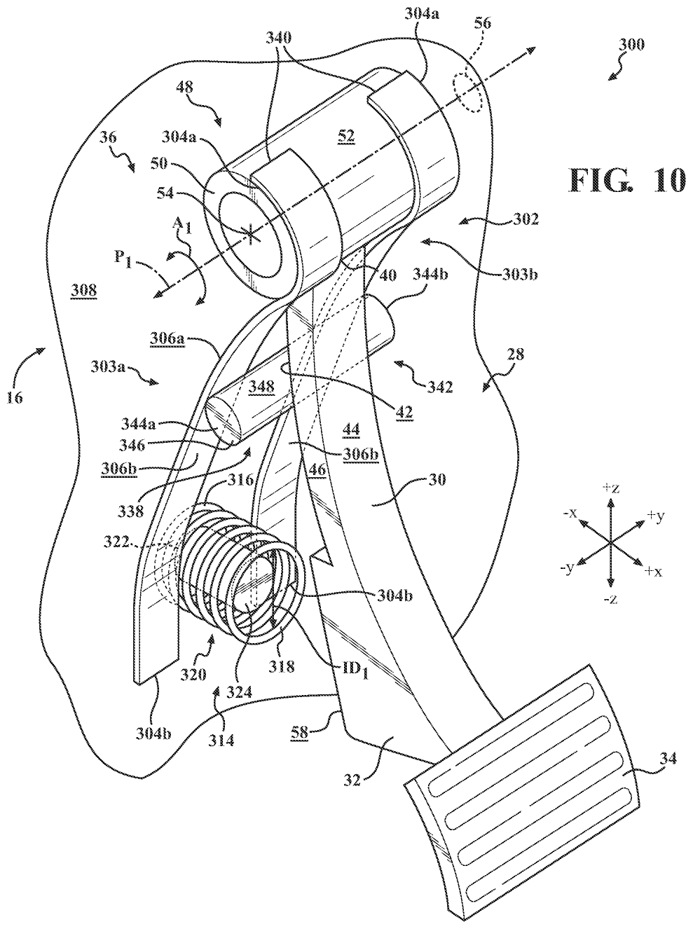

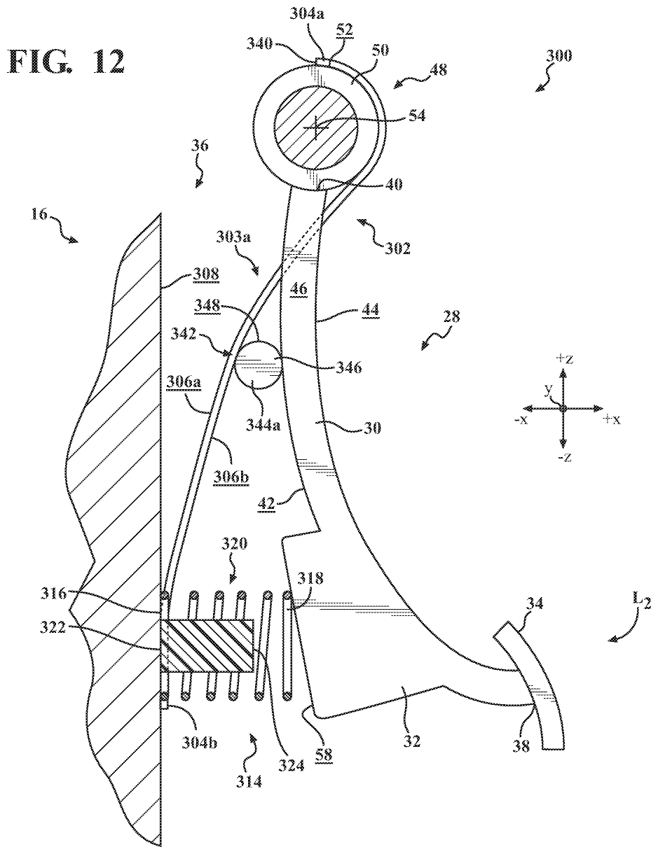

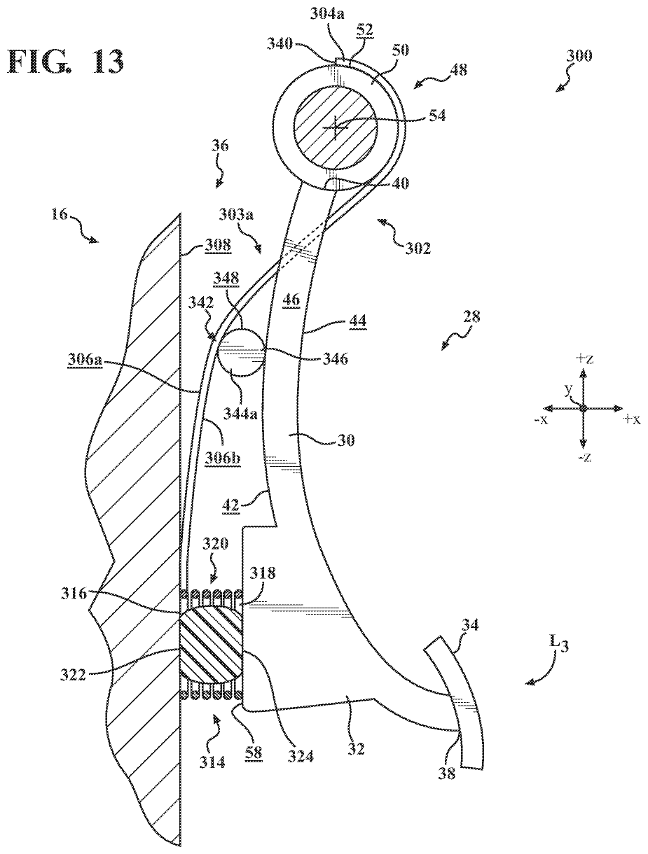

Now referring to FIGS. 10-13, a third aspect of an emulator assembly 300 is schematically depicted. It is understood that the emulator assembly 300 is similar to the emulator assembly 100 with the exceptions of the features described herein. As such, like features of the pedal assembly will use the same reference numbers and like features of the emulator assembly will use the same reference numerals with a prefix “3” for the reference numbers. As such, for brevity reasons, these features may not be described again.

In this embodiment, the tension member 302 is a pair of tension members 303a, 303b that are spaced apart from one another and extend from the hub portion 48 to a position below the at least one spring member 314 and/or the at least one compressible member 320 in the vertical direction (i.e., in the +/−Z direction) to abut, engage, or otherwise be in communication with the interior wall surface 308 of the rear wall 16. In this embodiment, the contact member end 304b may be configured to abut, engage, or otherwise be in communication with the interior wall surface 308 of the rear wall 16.

In some embodiments, each of the pair of tension members 303a, 303b may be symmetrical and have a generally curvilinear or arcuate shape and are spaced apart by a gap or opening 338. In other embodiments, each of the pair of tension members 303a, 303b may not be symmetrical. For ease of understanding, the tension member 302 is referring to both of the pair of tension members 303a, 303b. The shape of the tension member 302 may assist in defining the predetermined tension of the tension member 302. As such, in this embodiment, the tension member 302 is shaped such that the contact member end 304b may abut, engage, or otherwise be in communication with the interior wall surface 308 of the rear wall 16 and the hub engagement end 304a may abut, engage with, or otherwise be in communication with the engagement surface 52 of the circumferential outer wall 50 of the hub portion 48.

The hub engagement end 304a may be dimensioned and geometrically shaped to match the curvature of the circumferential outer wall 50. As such, the hub engagement end 304a is arcuate or curvilinear in shape. The hub engagement end 304a may be or include a terminating end 340 that abuts, engages with, or is otherwise in communication with the engagement surface 52 of the circumferential outer wall 50 of the hub portion 48. Further, in this embodiment, the hub engagement end 304a and/or the terminating end 340 may be positioned to engage with the engagement surface 52 of the circumferential outer wall 50 of the hub portion 48 nearest or in a direction with respect from the inner surface 42 to the outer surface 44 of the elongated member 30. That is, the hub engagement end 304a and/or the terminating end 340 may extend around the engagement surface 52 of the circumferential outer wall 50 of the hub portion 48 in the longitudinal direction (i.e., in the +X direction to the —X direction).

Further, a cross member 342 is positioned to extend from the inner surface 42 of the elongated member 30 between the tension member 302 and the inner surface 42 of the elongated member 30. The cross member 342 may include a pair of ends 344a, 344b, and a circumferential wall 346 that includes an exterior surface 348.

In some embodiments, portions of the exterior surface 348 of the cross member 342 may be coupled or otherwise attached to the inner surface 42 via the tension generated or created by the tension member 302. In other embodiments, the exterior surface 348 of the cross member 342 is fixedly coupled to the inner surface 42. As such, a fastener may be used to fixedly couple the cross member 342 to the inner surface 42, for example, without limitation, bolt and nut, screw, rivet, hook and loop, weld, adhesive, epoxy, and/or the like that may be attached between the inner surface 42 and the cross member 342 and/or between the cross member 342 and other components of the housing 12. In the depicted embodiment, the cross member 342 cylindrical in shape. In other embodiments, the cross member 342 may be any shape including hexagonal, octagonal, triangular, square, rectangular, cone, and the like. In some embodiments, the cross member 342 may be a round stock, dowel, pin, and the like.

The cross member 342 may be positioned such that a different portion of the exterior surface 348 makes contact or other abut or engage with the tension member 302 between the hub engagement end 304a and the contact member end 304b. That is, a different portion of the cross member 342 is positioned to abut, engage, or otherwise be in communication with the inner surface 42 than the portion of the cross member 342 that abuts, engages, or otherwise is in communication with the tension member 302.

In some embodiments, the contact member end 304b may terminate against the interior wall surface 308 of the rear wall 16 at a position in the cavity 36 that is below the at least one spring member 314 and/or the at least one compressible member 320 in the vertical direction (i.e., in the +/−Z direction).

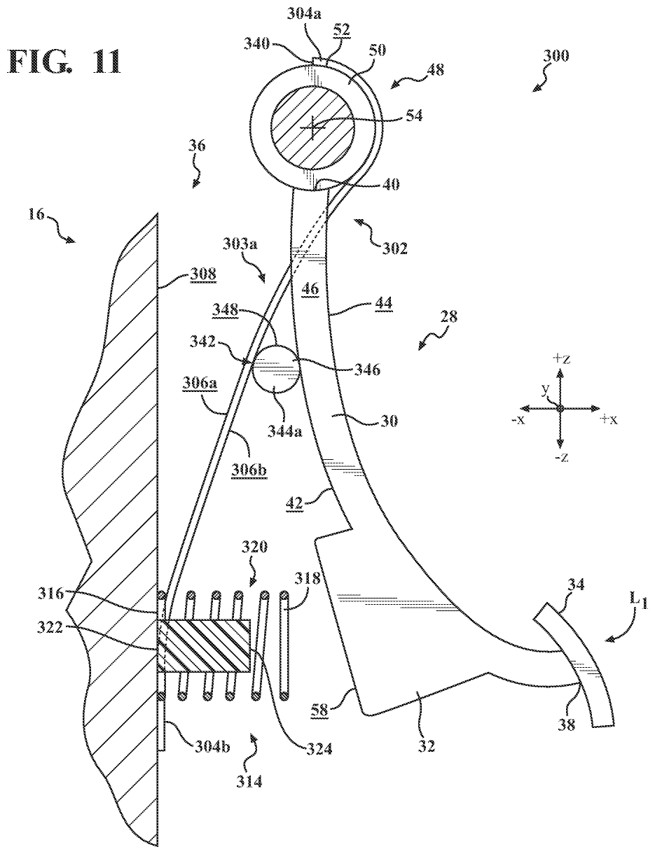

In some embodiments, the hub engagement end 304a of the tension member 302 is held in a position or arrangement to abut, engage with, or otherwise be in communication with the engagement surface 52 of the circumferential outer wall 50 of the hub portion 48 and the cross member 342 via the resting tension of the tension member 302. As such, the contact member end 304b is held in a position or arrangement to engage with, or otherwise be in communication with the interior wall surface 308 of the rear wall 16 by the resting tension of the tension member 302 (as best shown in FIG. 11) generated or created by the shape of the tension member 302, and/or the contact, engagement, otherwise in communication with the cross member 342, the engagement surface 52 of the circumferential outer wall 50 of the hub portion 48 and/or the interior wall surface 308 of the rear wall 16 of the housing 12.

As such, in this embodiment, the tension member 302 may be independent from or otherwise not permanently coupled or attached to the pedal arm 28 or components thereof, and instead the positioning, shape, and contact points, portions, and/or positioning of the tension member 302 generates the tension needed or required to maintain the tension member 302 under a constant resting tension to maintain the positioning of the tension member 302 in the emulator assembly 300. As such, the tension member 302 is held in position by a tension fit.

In other embodiments, the hub engagement end 304a of the tension member 302 is coupled or otherwise attached to the engagement surface 52 of the circumferential outer wall 50 of the hub portion 48. The hub engagement end 304a of the tension member 302 may be coupled or otherwise attached via a fastener. Example fasteners include, without limitation, bolt and nut, screw, rivets, weld, epoxy, adhesive, and/or the like. As such, in this embodiment, instead of a tension fit, the hub engagement end 304a of the tension member 302 is held in a position or arrangement to abut, engage with, or otherwise be in communication with the engagement surface 52 of the circumferential outer wall 50 of the hub portion 48 via the fastener.

In other embodiments, the contact member end 304b of the tension member 302 is held in a position or arrangement to engage with, or otherwise be in communication with the interior wall surface 308 of the rear wall 16 via a fastener. Example fasteners include, without limitation, bolt and nut, screw, rivets, weld, epoxy, adhesive, and/or the like. It should be understood that the contact member end 304b of the tension member 302 may be held in a position or arrangement to engage with, or otherwise be in communication with the interior wall surface 308 of the rear wall 16 via the fastener while the hub engagement end 304a of the tension member 302 may be coupled to the or otherwise attached to either the engagement surface 52 of the circumferential outer wall 50 of the hub portion 48 and/or the inner surface 42 of the elongated member 30 via the tension fit and vice versa, as discussed above.

As such, the tension fit described herein requires nothing more than the tension or force generated or created by the tension member 302 that may be based on the shape and/or material of the tension member 302, the arrangement of the tension member 302 against the pedal arm 28 and/or the interior wall surface 308 of the housing 12, and the like.

Still referring to FIGS. 10-13 and now back to FIGS. 22-23, in operation, as a first predetermined load L1 is applied to the pedal pad 34, as best illustrated in FIG. 11, the engagement surface 52 of the circumferential outer wall 50 of the hub portion 48 may rotate, pivot, or otherwise move, about arrow A1, thereby concurrently or simultaneously moving, rotating, or pivoting the hub engagement end 304a of the tension member 302. Such movement causes the tension member 302 to generate or create an increasing tension due to the contact member end 304b abutting, engaging with, or otherwise in communication with the interior wall surface 308 of the rear wall 16 of the housing 12 and/or the hub engagement end 304a abutting, engaging with, or otherwise in communication with the engagement surface 52 of the circumferential outer wall 50 of the hub portion 48 and/or the tension member 302 abutting, engaging with, or otherwise in communication with the cross member 342.

As such, the tension generated or created by the tension member 302 is dependent on the amount of first predetermined load L1 applied to the pedal pad 34. That is, the hub portion 48 moves, which drives the tension member 302 towards the interior wall surface 308 of the housing 12 such that a tension generated or created the tension member 302 generates the first force feedback onto the pedal pad 34, illustrated by bracket 2202 in FIG. 22, dependent on the first predetermined load L1 applied to the pedal pad 34.

Further, in the emulator assembly 300, the at least one spring member 314 and the at least one compressible member 320 extend between the pair of tension members 303a, 303b in the gap or opening 338.

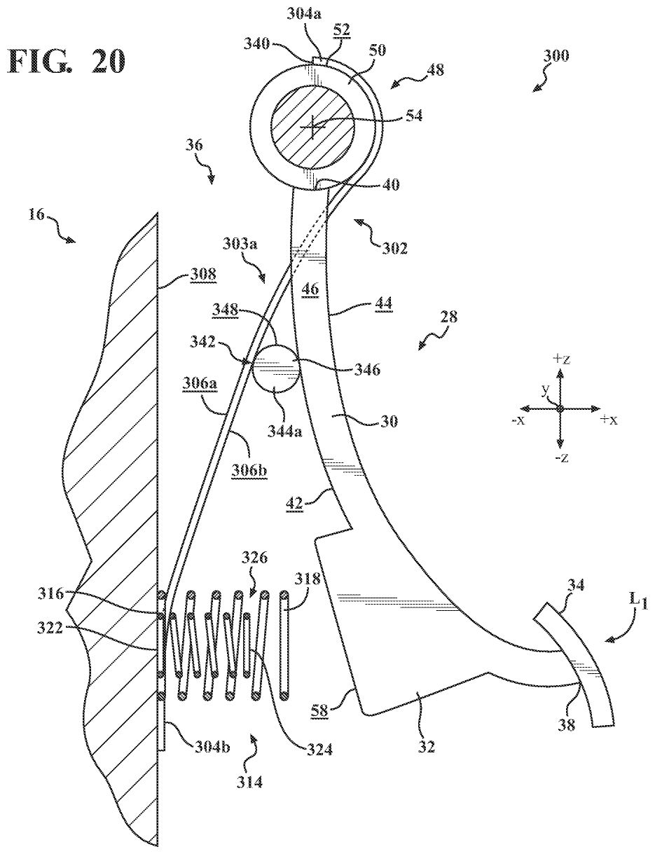

Now referring to FIG. 20, in other embodiments, the at least one compressible member 320 may be a second spring 326. The second spring 326 may have a greater compression rate (e.g., higher stiffness) compared to the at least one spring member 314 such that the second spring 326 produces the sharp increase in slope compared to the increase produced by the tension member 302 and/or the at least one spring member 314, as illustrated in FIG. 22. As such, the second spring 326 may replace the foam or elastomer material to generate the third force feedback applied to the pedal pad 34.

In some embodiments, the second spring 326 may be formed with a steel material. In other embodiments, the second spring 326 may be formed with stainless steel, wire, carbon steel, alloy steel, elgiloy, Monel®, copper, nickel, and/or the like. Further, in some embodiments, the second spring 326 may be a coil spring. In other embodiments, the second spring 326 may be a torsion spring, a tension spring, a conical spring, and/or the like.

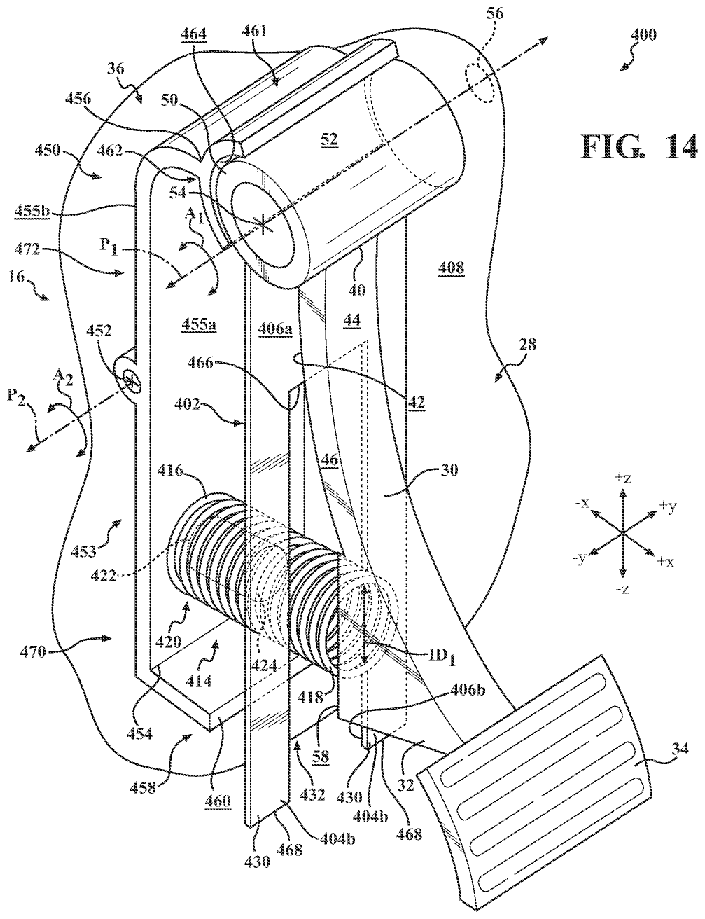

Now referring to FIGS. 14-17, a fourth aspect of an emulator assembly 400 is schematically depicted. It is understood that the emulator assembly 400 is similar to the emulator assembly 100 with the exceptions of the features described herein. As such, like features of the pedal assembly will use the same reference numbers and like features of the emulator assembly will use the same reference numerals with a prefix “4” for the reference numbers. As such, for brevity reasons, these features may not be described again.

In this embodiment, the emulator assembly 400 includes a tension member 402 and a pivoting member 450. The pivoting member 450 is pivotally coupled to the interior wall surface 408 of the rear wall 16 of the housing 12 and is positioned to extend in the vertical direction (i.e., in the +/−Z direction) within the cavity 36. The pivoting member 450 may be pivotally coupled to the interior wall surface 408 of the rear wall 16 via a pivoting portion 452 that may be rotatably mounted a recess 409 positioned within the interior wall surface 408 of the housing 12 in any known manner such as an engagement of pins, rods, and the like, extending from or into the pivoting portion 452 of the pivoting member 450. As such, the pivoting member 450 rotates about the pivoting portion 452, which defines a pivot axis P2 for the pivoting member 450 about arrow A2.

The pivoting member 450 may include a body 453 that includes a distal end 454, at the lower end, and an opposite proximal end 456, at an upper end. The body 453 may include an outer surface 455a and an opposite inner surface 455b spaced apart to define a thickness therebetween. The inner surface 455b may face the interior wall surface 408 of the rear wall 16 while the outer surface 455a may face the inner surface 42 of the elongated member 30. Further, the pivoting member 450 may include a lower portion 470 positioned below the pivoting member 450 in the vertical direction (i.e., in the +/−Z direction) and an upper portion 472 positioned above the pivoting member 450 in the vertical direction (i.e., in the +/−Z direction).

A lower flange portion 458 may extend from the distal end 454 of the body 453 in a longitudinal direction (i.e., in the +/−X direction) in a direction away from the interior wall surface 408 of the rear wall. In some embodiments, the lower flange portion 458 may extend in a linear direction and includes a tension spring contact surface 460 that is configured to abut, engage, or otherwise make or be in contact with the tension member 402, as discussed in greater detail herein. In other embodiments, the lower flange portion 458 may be arcuate, curvilinear, and the like. In some embodiments, the lower flange portion 458 may be integrally formed with, as a single monolithic structure, with the body 453 of the pivoting member 450. In other embodiments, the lower flange portion 458 may be coupled or otherwise attached to the distal end 454 of the body 453 via a fastener. Example fasteners include, without limitation, bolt and nut, screw, rivet, hoop and loop, weld, epoxy, adhesive, and/or the like.

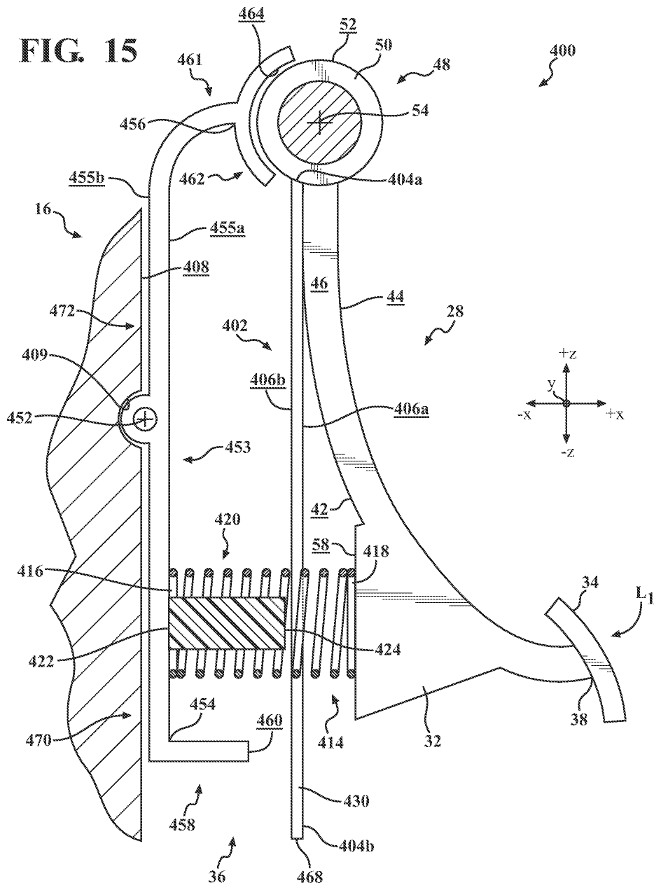

The body 453 may have a curvilinear portion 461 that extends in the longitudinal direction (i.e., in the +/−X direction) in a direction opposite of the interior wall surface 408 and towards the inner surface 42 of the elongated member 30. As such the proximal end 456 may be positioned at a position further from the interior wall surface 408 than the distal end 454 when the is no load or minimal load applied to the pedal pad 34, as best illustrated in FIG. 15.

An upper flange portion 462 may extend from the proximal end 456 of the body 453 in a longitudinal direction (i.e., in the +/−X direction) in a direction away from the interior wall surface 408 of the rear wall 16. In some embodiments, the upper flange portion 462 may be an arcuate or curvilinear in shape to be dimensionally or geometrically shaped to match the curvature of the circumferential outer wall 50 of the hub portion 48. The upper flange portion 462 may further include a hub contact surface 464 that may be arcuate or curvilinear in shape and may be configured to abut, engage, or otherwise be in communication with the engagement surface 52 of the circumferential outer wall 50 of the hub portion 48, as discussed in greater detail herein. In other embodiments, the upper flange portion 462 may be other shapes. In some embodiments, the upper flange portion 462 may be integrally formed with, as a single monolithic structure, with the body 453 of the pivoting member 450. In other embodiments, the upper flange portion 462 may be coupled or otherwise attached to the proximal end 456 of the body 453 via a fastener. Example fasteners include, without limitation, bolt and nut, screw, rivet, hoop and loop, weld, epoxy, adhesive, and/or the like.

The tension member 402 extends from the hub portion 48 and/or from or adjacent to the proximal end 40 of the elongated member 30 to a position below the distal end 454 and/or the lower flange portion 458 of the pivoting member 450 in the vertical direction (i.e., in the +/−Z direction). In this embodiment, the contact member end 204b may be spaced apart from the interior wall surface 408 of the rear wall 16 of the housing and is configured to abut, engage, or otherwise be in communication with the tension spring contact surface 460 of the lower flange portion 458 of the pivoting member 450, as discussed in greater detail herein.

The tension member 402 may be planar or linear in shape. The shape of the tension member 402 may assist in defining the predetermined tension of the tension member 402. As such, in this embodiment, the tension member 402 is shaped such that the contact member end 404b may abut, engage, or otherwise be in communication with the lower flange portion 458 and the hub engagement end 404a may abut, engage with, or otherwise be in communication with the engagement surface 52 of the circumferential outer wall 50 of the hub portion 48 and/or abut, engage with, or otherwise be in communication with the inner surface 42 of the elongated member 30.

A terminating portion of the hub engagement end 404a may be dimensioned and geometrically shaped to match the curvature of the circumferential outer wall 50 and/or the hub engagement end 404a may be dimensioned and geometrically shaped to match the curvature of the inner surface 42 of the elongated member 30. In some embodiments, the hub engagement end 404a of the tension member 402 is held in a position or arrangement to abut, engage with, or otherwise be in communication with the engagement surface 52 of the circumferential outer wall 50 of the hub portion 48 and/or abut, engage with, or otherwise be in communication with the inner surface 42 of the elongated member 30.

In this embodiment, the contact member end 404b includes a pair of legs 430, tongues, or members, extending from a base portion 466, and that are each spaced apart by an opening 432 to form a general U-shape. As such, the contact member end 404b may include a pair of terminating ends 468 that extend beyond the lower flange portion 458 in the vertical direction (i.e., in the +/−Z direction). As such, in some embodiments, the pair of terminating ends 468 may terminate at a position in the cavity 36 that is below the at least one spring member 414 and/or the at least one compressible member 420 in the vertical direction (i.e., in the +/−Z direction).

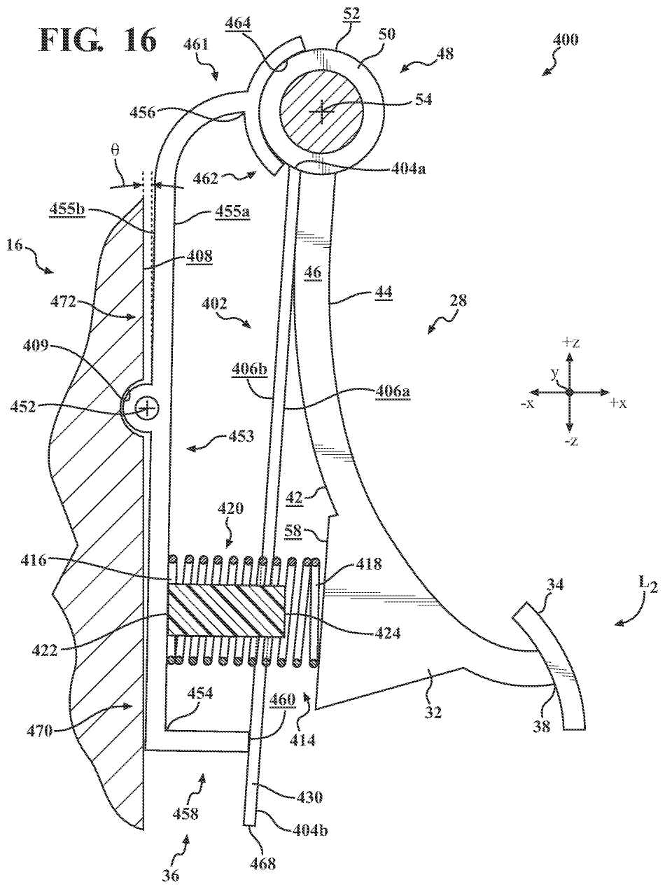

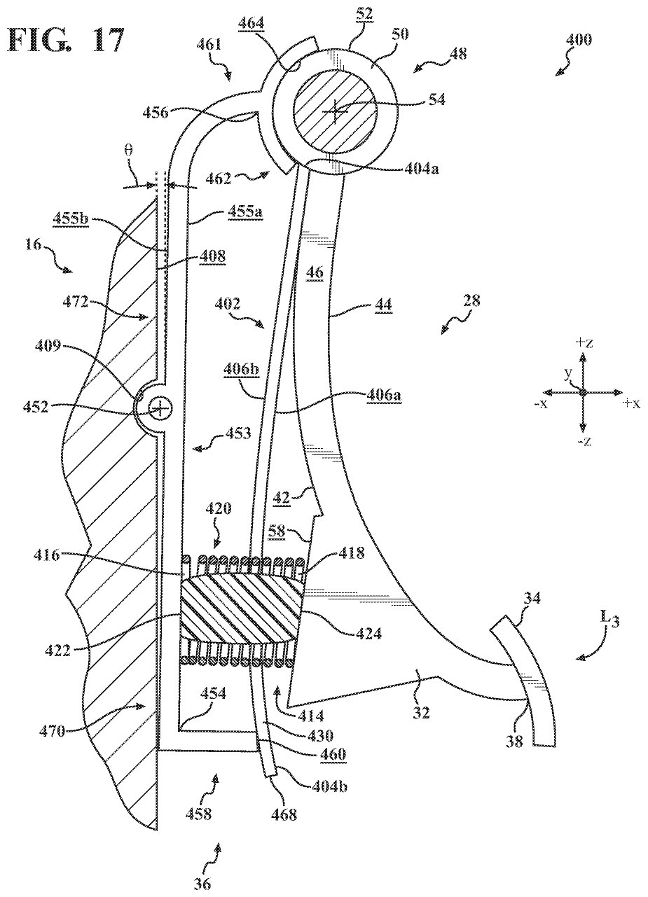

In some embodiments, the contact member end 404b (e.g., the pair of terminating ends 234) is held in a position or arrangement to engage with, or otherwise be in communication with the lower flange portion 458 by various forces applied to the tension member 402 (as best shown in FIGS. 16-17) generated or created by the shape of the tension member 402, and/or the contact, engagement, otherwise in communication with pivoting member 450.

As such, in this embodiment, the tension member 402 may be fixedly coupled or otherwise attached to the pedal arm 28 or components thereof, and the positioning, shape, and contact points, portions, and/or positioning of the tension member 402, the at least one spring member 414, the at least one compressible member 420 and/or the pivoting member 450 generates the various force curves, as illustrated in FIG. 22.

In some embodiments, the hub engagement end 404a of the tension member 402 is fixedly coupled or otherwise attached to the engagement surface 52 of the circumferential outer wall 50 of the hub portion 48 and/or to the inner surface 42 of the elongated member 30 of the pedal arm 28 via a fastener. Example fasteners include, without limitation, bolt and nut, screw, rivets, weld, epoxy, adhesive, and/or the like. As such, in this embodiment, instead of a tension fit, the hub engagement end 404a of the tension member 402 is held in a position or arrangement to abut, engage with, or otherwise be in communication with either the engagement surface 52 of the circumferential outer wall 50 of the hub portion 48 and/or with the inner surface 42 of the elongated member 30 via the fastener.

It should be appreciated that the contact member end 404b (e.g., the terminating ends 468) of the tension member 402 is free floating or other otherwise held in a position spaced apart from the lower flange portion 458 in the home position and/or during the first predetermined load L1 applied to the pedal pad 34, as best illustrated in FIG. 15. In this embodiment, the at least one spring member 414 and the at least one compressible member 420 extend from the outer surface 455a of the body 453 of the pivoting member 450. The contact end 418 of the at least one spring member 414 is configured to engage with the contact surface 58 of the contact member 32 in the home position and/or during the first predetermined load L1 applied to the pedal pad 34.

In some embodiments, the pivoting member 450 may be formed with various materials such as acrylonitrile butadiene styrene (ABS), polyethylene (PE), polypropylene (PP), polycarbonate (PC), polyamide thermoplastic (PA) —known as nylon—and variations of nylon including PA6 and PA66, Polyphthalamide (PPA), polycarbonate/acrylonitrile butadiene styrene, polyurethane, polymethyl methacrylate, high density polyethylene, low density polyethylene, polystyrene, PEEK, POM (Acetal/Delrin), polyethylene terephthalate, thermoplastic elastomer, polyetherimide, thermoplastic vulcanizate, polysulfone, steel, aluminum, alloys, iron, and/or the like, and combinations thereof. Additionally, additives may be added such as UV absorbers, flame retardants, colorants, glass fibers, plasticizers, carbon fiber, aramid fiber, glass bead, PTFE, PFPE, TALC, MoS2 (Molybdenum Disulfide), graphite, and/or the like. The pivoting member 450 may be formed using injection molding techniques, addictive manufacturing techniques (e.g., three-dimensional printing), and/or the like.

Still referring to FIGS. 14-17 and now back to FIGS. 22-23, in operation, as the first predetermined load L1 is applied to the pedal pad 34, as best illustrated in FIG. 15, the elongated member 30 and the engagement surface 52 of the circumferential outer wall 50 of the hub portion 48 may rotate, pivot, or otherwise move, about arrow A1, thereby concurrently or simultaneously driving the inner surface 42 of the elongated member 30 into the at least one spring member 414. Such movement causes the at least one spring member 414 to compress against the outer surface 455a thereby creating or generating the first force feedback onto the pedal pad 34, illustrated by bracket 2202 in FIG. 22, which is dependent on a variable pedal travel of the first predetermined load L1 applied to the pedal pad 34.

Further, it should be understood that the at least one spring member 414 also applies a return force to the pedal arm 28 when the first predetermined load L1 is reduced or eliminated from the application onto the pedal pad 34 such that the pedal arm 28 and pedal pad 34 may return to a home position when no load is applied to the pedal pad 34.

As such, the at least one spring member 414 extends within the cavity 36 of the housing 12 between the outer surface 455a of the pivoting member 450 and the contact surface 58 of the contact member 32. As such, the contact end 118 of the at least one spring member 114 may be configured to abut, engage with, or otherwise be in communication with the contact surface 58 of the contact member 32 when no load and/or when the first predetermined load L1 is applied to the pedal pad 34, as best illustrated in FIG. 15.

When the second predetermined load L2 is applied to the pedal pad 34, contact end 118 of the at least one spring member 114 may be further driven by the contact surface 58 of the contact member 32 to further compress the at least one spring member 114, and to pivot the pivoting member about the pivot axis P1 indicated by the arrow A2 at an angle, illustrated by arrow θ1, and such that the contact member end 404b of the tension member 402 abuts, engages with, or is otherwise in communication with the tension spring contact surface 460 of the lower flange portion 458 of the pivoting member 450 and a portion of the inner surface 455b of the pivoting member 450 abuts or engages with the interior wall surface 408 of the rear wall 16 to inhibit further pivoting of the pivoting member 450 to control the pivot a predetermined distance. The second predetermined load L2 is greater than the first predetermined load L1.

As such, the tension generated or created by the compression of the at least one spring member 114 and the inherent tension in the tension member 402 applied against the lower flange portion 458 of the pivoting member 450 is dependent on the amount of the predetermined load L2 applied to the pedal pad 34. The force generated by the further compression of the at least one spring member 114 caused from contact between the outer surface 455a of the pivoting member 450 and/or the contact surface 58 of the contact member 32 with the at least one spring member 114 and the contact and tension generated from the tension member 402 interacting with the lower flange portion 458 of the pivoting member 450 generates a second force feedback onto the pedal pad 34, illustrated by bracket 2204 in FIG. 22, dependent on the second predetermined load L2 applied to the pedal pad 34. As illustrated, the second force feedback, illustrated by bracket 2204 in FIG. 22, applied onto the pedal pad 34, is greater than the first force feedback illustrated by bracket 2202 in FIG. 22. Further, the second predetermined load L2 is a greater energy or load than the energy inherent in the at least one spring member 114.

Once the force on the pedal pad 34 is reduced or eliminated, the energy of the at least one spring member 114 (e.g., potential and kinetic) may assist in applying a return force the pedal arm 28 when the second predetermined load L2 is reduced or eliminated from the application onto the pedal pad 34 such that the pedal arm 28 and pedal pad 34 may return to a position associated with the first predetermined load L1.

The at least one compressible member 420 extends in the cavity 36 and from the outer surface 455a of the body 453 of the pivoting member 450 in the longitudinal direction (i.e., in the +/−X direction). The at least one compressible member 420 may include the attachment end 422 and the opposite interaction end 424. The attachment end 422 may be fixedly coupled or otherwise attached to the outer surface 455a of the body 453 via a fastener. Example fasteners include, without limitation, bolt and nut, screw, rivet, hook and loop, weld, adhesive, epoxy, and/or the like. The attachment end 122 is positioned to extend away from the outer surface 455a towards the contact member 32 of the pedal arm 28.

As such, when the third predetermined load L3 is applied to the pedal pad 34, the contact member end 404b of the tension member 402 against the lower flange portion 458 a greater amount than that with the second predetermined load L2, and/or the contact surface 58 of the contact member 32 abutting, engaging with, or otherwise be in communication with the interaction end 124 of the at least one compressible member 120 to compress and/or deform the at least one compressible member 120 dependent on the amount of load applied to the pedal pad 34 generates or creates the third force feedback onto the pedal pad 34, illustrated by bracket 2206 in FIG. 22. As such, and as best illustrated in FIG. 17, the tension applied to the tension member 402 against the lower flange portion 458 is greater because the pivoting member 450 is inhibited from further movement due to the inner surface in communication with the interior wall surface 408 of the rear wall 16 when compared to the tension applied with the second predetermined load L2, as best illustrated in FIG. 16.

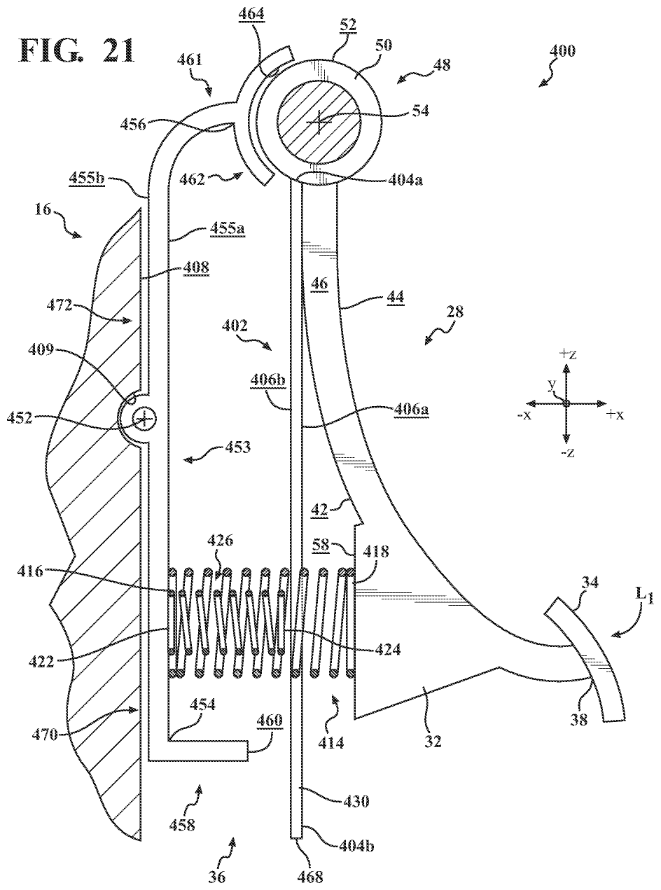

Now referring to FIG. 21, in other embodiments, the at least one compressible member 420 may be a second spring 426. The second spring 426 may have a greater compression rate (e.g., higher stiffness) compared to the at least one spring member 414 such that the second spring 426 produces the sharp increase in slope compared to the increase produced by the tension member 402 and/or the at least one spring member 414, as illustrated in FIG. 22. As such, the second spring 426 may replace the foam or elastomer material to generate the third force feedback applied to the pedal pad 34.

In some embodiments, the second spring 426 may be formed with a steel material. In other embodiments, the second spring 426 may be formed with stainless steel, wire, carbon steel, alloy steel, elgiloy, Monel®, copper, nickel, and/or the like. Further, in some embodiments, the second spring 426 may be a coil spring. In other embodiments, the second spring 426 may be a torsion spring, a tension spring, a conical spring, and/or the like.

It should now be understood that the pedal assembly described herein includes three different components and/or combinations, which may each or in combination be configured to provide a different pedal effort force to a pedal arm as a function of travel of the pedal arm. For example, the pedal assembly includes a tension member coupled to the pedal arm, at least one spring member, and at least one compressible member. Each provide a different pedal effort onto the pedal arm depending on the amount of travel of the pedal arm and the summation of the pedal effort forces apply at the fully travel position of the pedal arm.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A pedal assembly comprising:
a housing having a cavity and an interior surface;
a pedal arm having a hub portion at one end positioned within the cavity of the housing and a pedal pad positioned on an another end of the pedal arm, the hub portion movably coupled to the housing, the hub portion having an engagement surface; and
at least one tension member having a distal end and an opposite proximal end, the distal end configured to engage with the engagement surface of the hub portion;
wherein when a first predetermined load is applied to the pedal pad, the hub portion moves which drives the at least one tension member against the interior surface of the housing such that at least a tension by the at least one tension member generates a first force feedback onto the pedal pad.

2. The pedal assembly of claim 1, further comprising:
at least one spring member extending from the interior surface of the housing towards the pedal arm.

3. The pedal assembly of claim 2, wherein:
when a second predetermined load is applied to the pedal pad, the hub portion further moves which drives at least a portion of the pedal arm to be in contact with the at least one spring member to at least partially compress the at least one spring member such that the at least one spring member generates a second force feedback onto the pedal pad.

4. The pedal assembly of claim 3, wherein the second predetermined load is greater than the first predetermined load and the second force feedback has a greater force than the first force feedback.

5. The pedal assembly of claim 3, further comprising:
at least one compressible member extending from the interior surface of the housing towards the pedal arm.

6. The pedal assembly of claim 5, wherein:
when a third predetermined load is applied to the pedal pad, the hub portion further moves which drives at least the portion of the pedal arm to be in further contact with the at least one compressible member to at least partially compress the at least one compressible member such that the at least one compressible member generates a third force feedback onto the pedal pad.

7. The pedal assembly of claim 6, wherein the third predetermined load is greater than the second predetermined load and the third force feedback has a greater force than the second force feedback.

8. The pedal assembly of claim 7, wherein the at least one compressible member is formed from a coil spring or is formed from an elastomer material.

9. The pedal assembly of claim 7, wherein the housing further comprises:
a protrusion extending from the interior surface,
wherein the at least one tension member is configured to engage with the protrusion when the first predetermined load is applied to the pedal pad such that the tension generated by the at least one tension member engaging with the protrusion generates at least a portion of the first force feedback onto the pedal pad.

10. The pedal assembly of claim 8, wherein the distal end of the at least one tension member is a pair of members spaced apart by an opening, the at least one compressible member and the at least one spring member extend from the interior surface and into the opening between the pair of members.

11. The pedal assembly of claim 8, wherein the at least one tension member is a pair of tension members that are spaced apart from another to define a gap, the pedal arm further comprises:
a cross member coupled to and extending from an inner surface of the pedal arm between the hub portion and the pedal pad and between an exterior surface of each of the pair of tension members between the proximal end and the distal end.

12. The pedal assembly of claim 11, wherein each of the pair of tension members are configured to engage with the cross member when the first predetermined load is applied to the pedal pad such that the at least a portion of the tension generated by the pair of tension members engaging with at least the cross member generates the first force feedback onto the pedal pad.

13. The pedal assembly of claim 12, wherein the at least one compressible member and the at least one spring member extend from the interior surface and into the gap between the pair of tension members.

14. A pedal assembly comprising:
a housing having a cavity and an interior surface;
a pivoting member positioned in the cavity and pivotally coupled to the interior surface of the housing, the pivoting member having a lower flange extending from a distal end;
a pedal arm having a hub portion at one end positioned within the cavity of the housing and a pedal pad positioned on an another end of the pedal arm, the hub portion movably coupled to the housing, the hub portion having an outer wall having an engagement surface;
at least one tension member having a distal portion and an opposite proximal end, the proximal end of the at least one tension member configured to engage with the engagement surface of the hub portion and the distal portion configured to engage with the lower flange; and
at least one spring member extending from an inner surface of the pivoting member towards the pedal arm and configured to be compressed by the pedal arm,
wherein when a first predetermined load is applied to the pedal pad, the pedal arm at least partially compresses the at least one spring member towards the inner surface of the pivoting member such that the at least one spring member generates a first force feedback onto the pedal pad.

15. The pedal assembly of claim 14, wherein:
when a second predetermined load is applied to the pedal pad, the hub portion further moves which drives the distal end of the at least one tension member to be in contact with the lower flange, which causes a lower portion of the pivoting member to make contact with the interior surface of the housing such that the at least one tension member generates a second force feedback onto the pedal pad.

16. The pedal assembly of claim 15, wherein the second predetermined load is greater than the first predetermined load and the second force feedback has a greater force than the first force feedback.

17. The pedal assembly of claim 15, further comprising:
at least one compressible member extending from the inner surface of the pivoting member towards the pedal arm.

18. The pedal assembly of claim 17, wherein when a third predetermined load is applied to the pedal pad, the hub portion further moves which drives the pedal arm to at least partially compress the at least one compressible member towards the inner surface of the pivoting member such that the at least one compressible member generates a third force feedback onto the pedal pad.

19. The pedal assembly of claim 18, wherein the third predetermined load is greater than the second predetermined load and the third force feedback has a greater force than the second force feedback.

20. The pedal assembly of claim 18, wherein the pivoting member further comprises:
an upper flange extending from a proximal end, the upper flange is arcuate in shape to dimensionally match the shape of the outer wall of the hub portion.
